(19) United States
(12) Patent Application Publication
(10) Pub. No.: US 2024/0337985 A1
(43) Pub. Date: Oct. 10, 2024

(54) TIMEPIECE

(71) Applicant: REALIZATION DESAL AG, Oberwil bei Zug (CH)

(72) Inventor: Michael BONKE, Oberwil bei Zug (CH)

(21) Appl. No.: 18/573,133

(22) PCT Filed: Jun. 1, 2022
(86) PCT No.: PCT/EP2022/064905

§ 371 Date: Jan. 31, 2024

(30) Foreign Application Priority Data
Jun. 25, 2021 (DE) 102021116555.5

(51) Int. Cl. G04C 3/12

(52) U.S. Cl. CPC G04C 3/12

(57) ABSTRACT

The invention relates to a watch, in particular a wristwatch, which comprises a clock generator arrangement and a watch case, in which the clock generator arrangement is arranged. The clock generator arrangement comprises a clock generator. The clock generator comprises a piezoelectric oscillation crystal and electrodes, wherein the piezoelectric oscillation crystal has a length, a width and a height each of at least 1 mm, preferably of at least 1.5 mm.

### CROSS-REFERENCE TO RELATED APPLICATIONS

This application is a National Stage of International Application No. PCT/EP2022/064905, filed Jun. 1, 2022, which claims priority based on German Patent Application Nos. 102021116555.5, filed Jun. 25, 2021, the entire disclosures of which are incorporated herein by reference.

### TECHNICAL FIELD

The invention relates to a watch, in particular a wristwatch, with a clock generator arrangement. The invention also relates to a method of manufacturing such a watch.

### BACKGROUND

Quartz watches, in which an oscillation quartz is used as a clock generator, are known from the state of the art.

In the case of oscillation quartzes, it is usually a matter of oscillation quartzes in the form of a tuning fork with two fork tines respectively. The fork tines of such a quartz fork oscillator each have a thickness of a few tenths of a millimeter. In rare cases, no quartz fork oscillators are used, but quartz plates with a thickness of also a few tenths of a millimeter or even lower than one tenth of a millimeter.

In quartz fork oscillators, the tuning fork-formed quartz part is usually embedded in a vacuum bell from glass, in higher-quality cases in a vacuum socket from metal. The reason for the vacuum that is built up around the oscillation quartz is mainly that surrounding air or a gas would disturb or rather slow down the oscillation process of the quartz. The higher the air or gas pressure around the oscillation quartz, the higher the damping by the air is and the slower the oscillation. Without the vacuum, this would also mean a deficiency in precision, when one for example drives into the mountains with a quartz watch and the frequency of the quartz oscillator and thus the speed of the watch changes due to a change in air pressure.

Another important aspect for the known oscillation quartzes is the so-called “ageing”. Quartz oscillators are usually manufactured from synthetic, “levorotatory” quartz, which is a pure silicon oxide. A migration of foreign atoms through the quartz leads to a change in the oscillation behavior and thus to a change in the reference frequency, what in turn leads to a decrease in the precision of the watch. Above all, evaporating substances of the adhesive, with which the electrodes are often glued on the quartz oscillators, are responsible for long-term ageing of the oscillation quartzes.

### SUMMARY

A watch, in particular a wristwatch, is described below, which comprises a clock generator arrangement and preferably a watch case, in which the clock generator arrangement is arranged. The clock generator arrangement comprises a clock generator, which comprises a piezoelectric oscillation crystal and electrodes, and which is preferably not arranged in a vacuum and/or exposed to ambient pressure.

Preferably, the piezoelectric oscillation crystal has a length, a width and a height each of at least 1 mm, preferably at least 1.5 mm, further preferably at least 3 mm, particularly preferably at least 5 mm. Thus, the piezoelectric oscillation crystal has a solid mass, which enables it to oscillate stably. In particular, the stability of the oscillation of the piezoelectric oscillation crystal is ensured without it having to be under vacuum. Therefore, a vacuum socket or vacuum bell for receiving the piezoelectric oscillation crystal can be dispensed with. Furthermore, the proposed dimensioning of the oscillation crystal has the advantage that the oscillation crystal is subject to no or only negligible ageing. Thus, the piezoelectric oscillation crystal fulfills the technical requirements of a precisely functioning frequency oscillator and can therefore serve as a clock generator for the clock generator arrangement of a watch. Furthermore, the piezoelectric oscillation crystal can be used as a decorative element of the watch due to its highly visible form and size as well as the elimination of a vacuum socket or vacuum bell. For these reasons, different piezoelectric oscillation crystals can be used for the clock generator of the clock generator arrangement. The watch can thus be individualized, thereby giving a high-quality flair to the watch. In addition, the piezoelectric oscillation crystal can be selected with regard to its material properties and piezoelectric or optical properties for the respective use. In particular, a natural or synthetic quartz crystal, a quartz variety such as a natural amethyst crystal or citrine crystal, a natural tourmaline oscillation crystal or a natural Swiss rock crystal can be used for the clock generator of the clock generator arrangement of the watch.

The length, the width and the height of the piezoelectric oscillation crystal extend in direction of a first axis, a second axis and a third axis of a three-dimensional coordinate system, wherein the first axis, the second axis and the third axis are perpendicular to each other. The coordinate system is preferably arranged at a vertex of the piezoelectric oscillation crystal.

Within the scope of the invention, the length, width and height refer to the actual oscillating part of the piezoelectric oscillation crystal. That is, the length, width and height of the piezoelectric oscillation crystal correspond to the dimensions of the piezoelectric oscillation crystal that are relevant to its oscillation. For example, in the case of a piezoelectric oscillation crystal in the form of a tuning fork, the fork tines are the part of the oscillation crystal that actually oscillates. This means, in particular, that the length, width and height of such a piezoelectric oscillation crystal correspond to the length, width and height of each of the fork tines.

In particular, length, width or height of a piezoelectric oscillation crystal are understood within the scope of the invention to be the respective dimension of a single edge of the oscillation crystal and not the sum of the dimensions of two edges of the oscillation crystal, which extend in the same direction, when the oscillation crystal is formed in such a way that a free space is formed between the edges. In particular, within the scope of the invention, length, width or height of an oscillation crystal are to be understood as the respective actual dimension of an edge of the oscillation crystal and not the “apparent dimension” of the oscillation crystal as a whole body, when the oscillation crystal is formed such that it has a free space between two opposite side surfaces of the oscillation crystal. For example, in the case of a piezoelectric oscillation crystal in the form of a tuning fork, a width of the piezoelectric oscillation crystal corresponds neither to the sum of the widths of the two fork tines nor to the apparent width of the oscillation crystal measured from a vertex of one fork tine to the respective vertex of the other fork tine, when the width of the free space between the two fork tines is taken into account in the measurement.

An electrical voltage can be applied to the electrodes, so that the piezoelectric oscillation crystal is caused to oscillate. For this purpose, the electrodes are arranged in an advantageous manner at surfaces of the piezoelectric oscillation crystal. According to one option, it can be advantageous, when the electrodes are attached to the surfaces of the piezoelectric oscillation crystal, in particular applied in a materially bonded manner, preferably glued, to the surfaces of the piezoelectric oscillation crystal. “Attached” in particular means within the scope of the invention that the electrodes are connected to the surfaces of the piezoelectric oscillation crystal.

According to an alternative advantageous option, the clock generator can comprise an electrode holder, to which the electrodes are attached. The electrode holder together with the electrodes attached thereto form an electrode arrangement. In this case, the electrode arrangement is to be understood as a separate component from the piezoelectric oscillation crystal. The electrodes are formed at surfaces of the electrode holder. In particular, the electrodes can be separate current-conducting elements that are connected to surfaces of the electrode holder. Alternatively, current-conducting layers can be applied on surfaces of the electrode holder.

The electrode holder is advantageously formed such that at a maximum oscillation amplitude of the piezoelectric oscillation crystal, i.e., at a maximum mechanical deformation of the oscillation crystal, the surfaces of the electrode holder, at which the electrodes are formed, are in contact with the piezoelectric oscillation crystal or rather the surfaces of the oscillation crystal, to which the electrical voltage must be applied, or are arranged at a distance from the oscillation crystal or rather from the said surfaces of the oscillation crystal. In the latter case, the electrode holder is advantageously formed such that the distance is small enough that, when a voltage is applied to the electrodes, a piezoelectric oscillation of the oscillation crystal can be initiated and maintained. In particular, the electrode holder is formed in such a way that it enables deformation of the piezoelectric oscillation crystal in at least one axis perpendicular to the electrical axis, or also in direction parallel to the electrical axis, due to the volume conservation of the oscillation crystal. The electrical axis is defined, in particular, by the surfaces of the piezoelectric oscillation crystal, to which a voltage is applied to initiate a piezoelectric oscillation of the oscillation crystal. The electrodes are advantageously dimensioned in such a manner that the surfaces of the piezoelectric oscillation crystal, to which an electrical voltage must be applied and the electrodes overlap, in particular completely, in direction of an axis, in which the piezoelectric oscillation crystal expands due to the piezoelectric oscillation. The regions of the electrode holder, which comprise the surfaces with the electrodes arranged thereon can advantageously be formed springily. Providing a separate electrode arrangement that comprises the electrodes has the advantage that a piezoelectrically initiated oscillation of the oscillation crystal is not damped by the electrodes, as they are not attached to the oscillation crystal.

The electrode holder can preferably also serve as a holder for holding the piezoelectric oscillation crystal. For this purpose, the electrode holder preferably has a receiving region/holding region for receiving/holding the piezoelectric oscillation crystal.

Taking this into account, it should be noted in summary that, within the scope of the invention, the phrase “arranged at surfaces of the piezoelectric oscillation crystal” in connection with the electrodes comprises, in particular, both a connection of the electrodes to surfaces of the piezoelectric oscillation crystal (integrated design of the electrodes in the piezoelectric oscillation crystal) and a separate formation of the electrodes from the piezoelectric oscillation crystal.

In the case of a regular cuboid, the piezoelectric oscillation crystal is set up to oscillate as a whole body. In other words, the entire volume of the piezoelectric oscillation crystal then serves as oscillation body. However, if the oscillation direction runs in such a way that the opposite facet is not parallel at a position but runs at an angle, then the crystal does not oscillate at this particular position.

Preferably, the piezoelectric oscillation crystal can be formed to be cuboidal. Within the scope of the present invention, the term “cuboidal” is advantageously understood to also mean small deviations from the cuboid form. In this respect, a body, which basically has the form of a cuboid but comprises rounded or chamfered edges, is also termed a cuboid within the scope of the invention. In particular, within the scope of the invention, a cuboidal body with rounded or chamfered edges is to be referred to as a cuboid, when a height of the rounded or chamfered region corresponds to at most 20%, preferably at most 10%, of the total height of the body.

Within the scope of the invention, the length, width or height of the piezoelectric oscillation crystal can also be characterized as a thickness, when the piezoelectric oscillation crystal is set up to oscillate in an oscillation direction corresponding to the direction of the length, width or height.

Preferably, the watch has a see-through region. The piezoelectric oscillation crystal is in this case formed and arranged in the watch such that the piezoelectric oscillation crystal is visible through the see-through region of the watch, so that the piezoelectric oscillation crystal serves as a gemstone of the watch. According to an alternative formulation, the piezoelectric oscillation crystal is preferably formed as a gemstone and arranged in the watch such that it is visible through the see-through region of the watch. Thus, the piezoelectric oscillation crystal can serve as a clock generator of the watch and at the same time as a jewel for decorative purposes in the watch.

Within the scope of the invention, the term “gemstone” advantageously means a stone, in particular a semi-precious or precious stone, which is faceted (i.e., not raw stone). The gemstone can in an advantageous manner comprise a crown and/or a pavilion. Within the scope of the invention, the crown is understood to be in particular the region of the gemstone, which comprises a table facet and/or crown facets of the gemstone. Correspondingly, within the scope of the invention, the pavilion is understood to be in particular the region of the gemstone, which comprises pavilion facets and/or a tapered region of the stone. The crown is preferably separated from the pavilion by a separating edge.

The see-through region of the watch can preferably comprise a region of a dial of the watch and/or a region of the watch case (e.g., the case bottom) and/or a watch glass of the watch, which in particular is arranged as a cover glass on the watch case. For example, when the case bottom includes a viewing window, or the dial is omitted, or the dial is formed partially see-through, an observer of the watch can look at the oscillation crystal through the watch glass and the see-through region of the dial, and accordingly through the viewing window on the back of the watch. The see-through region can be formed as an opening of the dial, wherein the piezoelectric oscillation crystal is arranged at the position of the opening in the dial, so that the dial does not cover the oscillation crystal. However, the see-through region can also comprise the entire region of the dial, especially, when the dial is completely dispensed with, as is usually the case with so-called skeleton watches. Alternatively, the see-through region can be formed as a transparent region or rather a viewing window, in particular as a viewing window in the case bottom. In the case of an at least partially see-through watch case, the observer of the watch can look at the oscillation crystal directly through the see-through region of the watch case.

Advantageously, the piezoelectric oscillation crystal can have a pavilion with pavilion facets. A pavilion angle is in this case selected such that a double total reflection of light takes place in the pavilion. This ensures that light, which enters the oscillation crystal from above, also leaves it upwards. As a result, an increased sparkle of the oscillation crystal can be achieved. It should be understood that in this design of the invention, the piezoelectric oscillation crystal is formed as a gemstone. Within the scope of the invention, the pavilion angle is to be understood as the angle that a pavilion facet relative to a plane that is parallel to a table facet of the oscillation crystal has. In this case, the pavilion facet is inclined towards the table facet or rather to a plane parallel to the table facet of the oscillation crystal. This means that a pavilion facet that is perpendicular to the table facet and parallel to said parallel plane of the oscillation crystal is not relevant for determining the pavilion angle of the oscillation crystal. In other words, an angle that is 90 degrees cannot be understood as a pavilion angle of the oscillation crystal. In particular, a pavilion angle is the angle that pavilion facets of the oscillation crystal that meet (or whose planes intersect), relative to the table facet or rather to said parallel plane have. The plane parallel to the table facet can also be characterized as table facet plane.

Alternatively, the piezoelectric oscillation crystal can advantageously have, at its bottom side, a plurality of facets forming a plurality of protrusions. The protrusions are arranged such that the protrusions form a corrugated profile. The facets of a respective protrusion are at an angle to each other, which is selected in such a way that a double total reflection of light takes place in the respective protrusion. As a result, light that enters the oscillation crystal from above and reaches the protrusion can be totally reflected in the protrusion and leave the oscillation crystal upwards again. This means that the piezoelectric oscillation crystal in the watch serves not only as a clock generator, but also as a gemstone of the watch. At the same time, the oscillation crystal can be formed due to the plurality of protrusions more compactly in its height than an oscillation crystal with a pavilion. This is advantageous, when the watch, in which the piezoelectric oscillation crystal is arranged, is formed as a wristwatch, which requires a more compact structure compared with other watches. Thus, oscillation crystals made of materials comprising a high critical angle, such as tourmaline, can also be used in the wristwatch. This is particularly advantageous, when the oscillation crystal should have a large surface area or rather a large table facet for collecting light. Otherwise, in the case of an oscillation crystal comprising a pavilion and formed from a material with a high critical angle, the pavilion of the oscillation crystal and thus the entire oscillation crystal would necessarily have to have a large height. When using an oscillation crystal made of a material with a high critical angle in a wristwatch, the critical angle must always be taken into account, because otherwise the oscillation crystal would be too high and would go beyond the spatial scope of the watch. However, when the bottom side of the piezoelectric oscillation crystal is made in the corrugated pattern described above, the critical angle can be maintained even without increasing the thickness of the oscillation crystal to the size actually required for this. Thus, one obtains the same quantity of reflected light as with an oscillation crystal with a pavilion and the oscillation crystal can still be kept “flat”.

Within the scope of the invention, the critical angle is also called the critical angle of total internal reflection and denotes the smallest incidence angle of a light beam on a boundary surface (measured from the perpendicular to the boundary surface), above which the light beam is totally reflected at the boundary surface.

The bottom side of the piezoelectric oscillation crystal, which can also be characterized as bottom region within the scope of the invention, is to be understood in particular as the region of the oscillation crystal that, in the mounted state of the oscillation crystal in the watch, faces the watch case and faces away from a watch glass of the watch. Correspondingly, an upper side of the oscillation crystal is to be understood as the region of the oscillation crystal, which, in the mounted state of the oscillation crystal in the watch, faces away from the watch case and faces the watch glass. The watch glass above the hands of the watch, as well as a viewing window at the back side of the watch, i.e., in the case bottom can be understood as watch glass.

### Formation of the Piezoelectric Oscillation Crystal (Clock Generator) as a Natural Tourmaline Oscillation Crystal

According to an advantageous design of the invention, the piezoelectric oscillation crystal of the clock generator is a natural tourmaline oscillation crystal having an L-axis, three TA-axes and three TS-axes. Thus, a watch can be provided with the accuracy of a conventional quartz watch having a synthetic quartz oscillation crystal, while at the same time being perceived as of high quality. Moreover, tourmaline has interesting optical and piezoelectric properties that allow a plurality of designs of the piezoelectric oscillation crystal and thus of the watch.

It should be noted that the L-axis, the TA-axes and the TS-axes are axes that basically refer to a tourmaline raw crystal, from which the tourmaline oscillation crystal is cut out. In other words, these axes describe the tourmaline raw crystal. However, these axes are also present in the tourmaline oscillation crystal. Thus, within the scope of the invention, formulations of the type “L-axis/TA-axis/TS-axis of the tourmaline raw crystal” are equivalent to formulations of the type “L-axis/TA-axis/TS-axis of the tourmaline oscillation crystal”. As piezoelectric polar axes, the TA-axes and the TS-axes in tourmaline run similar to the Y-axes and the X-axes in the quartz crystal.

It should also be noted that the three TA-axes are in particular equivalent to each other with regard to the piezoelectric properties of the tourmaline raw crystal. Correspondingly, the three TS-axes are in particular equivalent to each other with regard to the piezoelectric properties of the tourmaline raw crystal.

Formation of the Piezoelectric Oscillation Crystal (Clock Generator) as a Natural Tourmaline Oscillation Crystal from a Tourmaline Raw Crystal with a Trigonal Structure

Preferably, the tourmaline oscillation crystal can be formed from a tourmaline raw crystal that has a trigonal structure (in light of the cross-section form of the raw crystal). That is, the tourmaline oscillation crystal used as the piezoelectric oscillation crystal in this design of the invention is formed from a tourmaline raw crystal that has crystallized trigonally, that is, in a triangular form. The formulation that the tourmaline raw crystal has a trigonal structure means that the tourmaline raw crystal has a trigonal (triangular) cross-section. In particular, the tourmaline raw crystal can have curved, in particular convexly curved, triangular sides.

The above-mentioned L-axis corresponds to the crystallographic longitudinal axis of tourmaline, which is also called the optical axis. This axis is also known as the Z-axis or often as the C-axis. The longitudinal axis is the axis that represents the direction of growth or the direction of crystallization of tourmaline. Within the scope of the invention, that axis of the tourmaline raw crystal, which is perpendicular to the crystallographic longitudinal axis and runs through an angle, which is spanned by two of the three facets of the tourmaline raw crystal, is characterized as TA-axis (TA: triangle-angle). Furthermore, within the scope of the invention, that axis of the tourmaline raw crystal, which is perpendicular to the crystallographic longitudinal axis and runs substantially parallel to the basic orientation of one of the three facets of the tourmaline raw crystal is characterized as TS-axis (TS: tourmaline side). The tourmaline raw crystal can be described by a structure triangle, the sides of which are assigned to or rather follow the facets of the tourmaline raw crystal. Thus, the crystallographic longitudinal axis is perpendicular to the plane of the structure triangle. Each TA-axis is perpendicular to the crystallographic longitudinal axis and runs centrally through an angle that is spanned by two of the three sides of the structure triangle. Each TS-axis is perpendicular to the crystallographic longitudinal axis and runs parallel to one of the three sides of the structure triangle. In other words, each TA-axis is an axis that runs as an angle bisector through one apex of the structure triangle, wherein each TS-axis is an axis that runs parallel to one triangle side of the structure triangle. The L-axis, the three TS-axes and the three TA-axes are piezoelectric-polar axes.

It should also be noted that the oscillation frequency of a tourmaline oscillation crystal in an oscillation direction is usually calculated according to the formula “F=K×1000000/D”, wherein “F” is the oscillation frequency in Hz, “K” is a parameter in mm/s, and “D” is the thickness of the tourmaline oscillation crystal in the respective oscillation direction in mm.

The piezoelectric oscillation crystal formed as natural tourmaline oscillation crystal preferably has a table facet.

The table facet can preferably be perpendicular to a TA-axis or a TS-axis, when the tourmaline oscillation crystal blocks a light transmission in direction of the L-axis.

The tourmaline oscillation crystal acts as polarization filter in direction of the TA-axis and the TS-axis, i.e., 90 degrees to the L-axis. Light that falls perpendicular to the L-axis on the tourmaline oscillation crystal is polarized as it flows through such a tourmaline oscillation crystal. A viewing direction of the observer on the table facet (perpendicular to the table facet) runs in this case perpendicular to the L-axis.

Most types of tourmaline (e.g., the Brazilian elbaites) block the light transmission almost completely or completely in direction of the L-axis. This means that the light transmission in direction of the L-axis is in many cases reduced to 0% to 5%. Within the scope of the present invention, the L-axis in this tourmaline oscillation crystal can be characterized as “optically closed” or “obscuring” axis. Thus, in this tourmaline oscillation crystal, it is advantageous, when the table facet of the piezoelectric oscillation crystal is not perpendicular to the L-axis. This means that it is advantageous in the mentioned types of tourmaline, when the table facet is formed such that a viewing direction of the observer on the table facet (perpendicular to the table facet) is not parallel to the L-axis.

However, when the tourmaline oscillation crystal allows light transmission in direction of the L-axis, the table facet can preferably be perpendicular to the L-axis, a TA-axis, or a TS-axis.

Within the scope of the invention, “an arrangement of an element, in which the element is arranged with a deviation of plus or minus 5 degrees, in special cases up to 10 degrees, from the respective perpendicular to the axis, can also be characterized as “perpendicular to an axis”.

Formation of the Piezoelectric Oscillation Crystal (Clock Generator) as a Natural Tourmaline Oscillation Crystal from a Tourmaline Raw Crystal with Hexagonal Structure

According to a further advantageous design of the invention, the piezoelectric oscillation crystal can be a natural tourmaline oscillation crystal formed from a tourmaline raw crystal having a hexagonal structure (based on the cross-section shape of the raw crystal). The occurrence of a hexagonal structure (based on the cross-section shape) is much rarer than the trigonal structure. Less than 10% of all natural tourmalines have a hexagonal structure. The hexagonal structure means that in this design of the invention, a natural tourmaline oscillation crystal that has crystallized hexagonally is used for the piezoelectric oscillation crystal. The formulation that the tourmaline raw crystal has a hexagonal structure means that the tourmaline raw crystal has a hexagonal cross-section.

Further, in some circumstances, the tourmaline oscillation crystal allows a light transmission in direction of the L-axis. In other words, the light transmission in the L-axis is in this case not blocked at all. Such raw crystals occur in certain (especially African) types of tourmaline or in certain find spots or tourmaline mines. It turns out that the hexagonal structure of tourmalines is very often found in those tourmaline types, in which the flow of light along the L-axis is not blocked. Within the scope of the present invention, the L-axis in such a tourmaline oscillation crystal can be characterized as an “optically open” axis. This means that one can see through, for example, a tourmaline slice cut off from the tourmaline raw crystal perpendicular to the L-axis, like through colored glass, and is not blocked in the view, as is normally the case with tourmaline oscillation crystals, for example from Brazil and then usually with a trigonal structure. For example, the tourmaline oscillation crystal, which is optically open and at the same time hexagonal is an African, in particular pink-colored, tourmaline, in particular from Nigeria.

Tourmaline oscillation crystals that are formed from a tourmaline raw crystal with a hexagonal structure and have an “optically open” L-axis have surprisingly been found to be piezoelectrically highly active. In particular, the oscillation of such tourmaline oscillation crystals is often stronger than that of tourmaline oscillation crystals formed from a tourmaline raw crystal with a trigonal structure. In particular, their piezoelectric activity can be up to 30% higher than that of tourmaline oscillation crystals made from tourmaline raw crystals with a trigonal structure. The hexagonal form is in particular in the case of larger, cuboidal oscillation crystals more weight-saving during grinding than the trigonally structured tourmaline raw crystals. Furthermore, the processing of tourmaline raw crystals with an open optical-axis and with a hexagonal form can be simplified, because during the forming process, in particular the cutting process, it is not necessary to pay attention to optical dangers due to a closed or obscuring L-axis.

The L-axis of a natural tourmaline oscillation crystal from a tourmaline raw crystal with a hexagonal structure denotes, as in the case of a natural tourmaline oscillation crystal from a tourmaline raw crystal with a trigonal structure, the crystallographic longitudinal axis of the tourmaline, which represents the direction of growth or the direction of crystallization of the tourmaline. A tourmaline raw crystal with a hexagonal structure can be described using a structure hexagon. With reference to the structure hexagon, each TA-axis passes through two parallel sides of the structure hexagon, wherein each TS-axis passes through two opposite vertices of the structure hexagon.

Preferably, the tourmaline oscillation crystal has a table facet that is perpendicular to the L-axis, a TA-axis or a TS-axis.

As an alternative to enabling a light transmission in direction of the L-axis, the tourmaline oscillation crystal can here also block a light transmission in direction of the L-axis, as in the case of a tourmaline oscillation crystal from a tourmaline raw crystal with a trigonal structure. In this case, the tourmaline oscillation crystal has a table facet that is perpendicular to a TA-axis or a TS-axis.

Formation of the Piezoelectric Oscillation Crystal (Clock Generator) as a Natural Tourmaline Oscillation Crystal from a Tourmaline Raw Crystal with a Trigonal or Hexagonal Structure and an Oscillation Direction Along the L-Axis

Preferably, the electrodes can be arranged at surfaces of the tourmaline oscillation crystal that are perpendicular to the L-axis. Here, the oscillation direction of a piezoelectrically excited oscillation of the tourmaline oscillation crystal runs along the L-axis.

Taking into account the above-described relationship between the oscillation frequency and the thickness of the tourmaline oscillation crystal in the oscillation direction, the arrangement of the electrodes at surfaces of the tourmaline oscillation crystal that are perpendicular to the L-axis the advantage that, when the case of an oscillation direction of the tourmaline oscillation crystal along the L-axis, the value of the parameter “K” for the same tourmaline oscillation crystal is not or only slightly dependent on the thickness of the tourmaline oscillation crystal in the L-axis. In other words, this means that the value of the parameter “K” remains relatively constant, when one and the same tourmaline oscillation crystal is cut narrower in the L-axis. Thus, the preparation of the piezoelectric oscillation crystal formed as a tourmaline oscillation crystal can be simplified, because a deviation of the thickness of the tourmaline oscillation crystal along the L-axis from a targeted thickness has no or only a small influence on the parameter “K”, and thus the oscillation frequency of the piezoelectric oscillation crystal is relatively exactly directly proportional to the distance between the two parallel oscillation surfaces, at which the electrodes are arranged. For tourmaline oscillation crystals with oscillation direction along the L-axis, the parameter “K” is normally (depending on the individual tourmaline) between 3.85 and 3.50.

It should also be noted that the parameter “K” in the direction along the L-axis is also relatively independent of the thickness of the tourmaline oscillation crystal along a TA-axis and of the thickness of the tourmaline oscillation crystal along a TS-axis. That is, that, when the tourmaline oscillation crystal has a certain thickness, a certain oscillation frequency and a certain “K” value in direction of the L-axis and the thickness of the tourmaline oscillation crystal is reduced in direction of a TA-axis or a TS-axis, the oscillation frequency and the value of the “K” parameter do not change significantly in direction of the L-axis. With reduction of the thickness of the tourmaline oscillation crystal in direction of a TA-axis and/or a TS-axis, the oscillation frequency and the value of the parameter “K” can be changed in the direction of the L-axis by up to 1% to 2%, depending on the magnitude of thickness reduction.

When the clock generator comprises a piezoelectric oscillation crystal formed as a natural tourmaline oscillation crystal and electrodes arranged at surfaces of the tourmaline oscillation crystal that are perpendicular to the L-axis, the tourmaline oscillation crystal preferably has pavilion facets that are inclined towards a TS-axis or a TA-axis and that each comprise two edges that run parallel to the L-axis. In other words, the inclined pavilion facets, which reflect the incident light, are not inclined towards the L-axis, but either towards a TA-axis or a TS-axis and at the same time run with two edges parallel to the L-axis. In an advantageous manner, when the pavilion facets are inclined in direction of the TS-axis, the TS-axis is parallel with the viewing direction of the viewer, wherein the viewing direction of the viewer is parallel with the TA-axis, when the pavilion facets are inclined in direction to the TA-axis. Thus, it can be avoided that light falling on the tourmaline oscillation crystal is swallowed by the pavilion facets, what is always the case, when the L-axis is not optically open.

Preferably, a pavilion angle is between 40 degrees and 50 degrees, and preferably at least 42 degrees. The pavilion angle of 42 degrees corresponds to the critical angle of tourmaline. Thus, a total reflection of light can take place in the tourmaline oscillation crystal.

The formulation that the pavilion facets are inclined towards a TA-axis or a TS-axis means that the pavilion facets are inclined in direction to the TA-axis or the TS-axis. In particular, this means that the lines that through the intersection of the pavilion facets with a plane defined by the TA-axis and the TS-axis meet on the TA-axis or the TS-axis. In particular, the pavilion facets have a common edge, which is parallel to the L-axis.

Alternatively, when the clock generator comprises a piezoelectric oscillation crystal formed as a natural tourmaline oscillation crystal and electrodes arranged at surfaces of the tourmaline oscillation crystal that are perpendicular to the L-axis, the piezoelectric oscillation crystal can in an advantageous manner have at its bottom side a plurality of facets forming a plurality of protrusions. The protrusions are arranged such that the protrusions form a corrugated profile. The facets of a respective protrusion are at an angle to a plane that is parallel to a table facet of the oscillation crystal, which is between 40 degrees and 50 degrees. In addition, the angle is preferably at least 42 degrees. At an angle of 42 degrees, a double total reflection of light takes place in the respective protrusion.

In an advantageous manner, each protrusion extends in direction along the L-axis of the tourmaline oscillation crystal. In other words, the protrusions are arranged parallel to the L-axis of the tourmaline.

In an advantageous manner, a table facet of the tourmaline oscillation crystal is perpendicular to a TA-axis. Here, the protrusions are arranged perpendicular to a TS-axis.

Alternatively, the table facet of the tourmaline oscillation crystal can be perpendicular to the TS-axis. In this case, the protrusions are arranged perpendicular to a TA-axis.

In particular in the case of a tourmaline oscillation crystal from a tourmaline raw crystal with a trigonal structure and of that category which blocks the light in direction parallel to the L-axis, the previously described design of the tourmaline oscillation crystal has the advantage that the tourmaline oscillation crystal can be used as a gemstone of the watch. If the table facet were perpendicular to the L-axis, the table facet would become opaque and the protrusions arranged at its bottom side would appear dark. If the facets were inclined towards the L-axis, the obscurity of the L-axis would be reflected into the oscillation crystal.

Formation of the Piezoelectric Oscillation Crystal (Clock Generator) as a Natural Tourmaline Oscillation Crystal from a Tourmaline Raw Crystal with a Trigonal or Hexagonal Structure and an Oscillation Direction Along a TA-Axis

Preferably, the electrodes can be arranged at surfaces of the tourmaline oscillation crystal, which are perpendicular to a TA-axis and run parallel to the L-axis. In this case, the oscillation direction of a piezoelectrically excited oscillation of the tourmaline oscillation crystal runs along a TA-axis. In an advantageous manner, the electrodes are here furthermore parallel to the TS-axis. In the case of a tourmaline oscillation crystal from a tourmaline raw crystal with a trigonal structure, the electrodes run parallel to a bisector of the structure triangle and parallel to the L-axis.

The orientation along the TA-axis is a very practical and easy-to-process orientation. In the case of the TA-axis orientation, there are always two unambiguous criteria in the case of the trigonally crystallized tourmaline raw crystal, according to which one can immediately recognize how to cut the tourmaline to obtain the correct facet. Firstly, one can simply place the facet in the center of a rounded triangular facet. On the other hand, one has the edge opposite this triangular facet, which represents a point of the structure triangle on the plane of the structure triangle. Thus, one can immediately and without long research place the facets on the tourmaline raw crystal precisely, which is very important for a clean frequency.

Furthermore, the tourmaline oscillation crystal has a stronger piezoelectric activity along the TA-axis than along the L-axis.

It should be noted that the parameter “K” in direction of the TA-axis in the abovementioned formula for calculating the oscillation crystal is dependent on the thickness of the tourmaline oscillation crystal in direction of the TA-axis. In particular, surprisingly, the value of the parameter “K” does not increase, or increases only very slightly, when the thickness of the tourmaline oscillation crystal in direction of the TA-axis is reduced.

In order to represent this behavior of the tourmaline oscillation crystals also arithmetically, exemplary values of the parameter “K” of a typical Brazilian tourmaline oscillation crystal in direction of the TA-axis depending on the thickness of the tourmaline oscillation crystal in direction of the TA-axis as well as the corresponding values of the oscillation frequency are indicated in the following table. As can be seen from the table, the value of the parameter “K” of this tourmaline oscillation crystal decreases, when the thickness of the tourmaline oscillation crystal in direction of the TA-axis is reduced. However, in this case, the decrease in the value of the parameter “K” with the reduction of the thickness of the tourmaline oscillation crystal in direction of the TA-axis is slight. This can also apply to other tourmaline oscillation crystals from a tourmaline raw crystal with a trigonal or hexagonal structure and an oscillation direction along a TA-axis.

| | | Oscillation | |
|---|---|---|---|
| Thickness of the | Parameter “K” of the | frequency of the | |
| tourmaline oscillation | tourmaline oscillation | tourmaline oscillation | |
| crystal in direction of | crystal in direction of | crystal in direction of | |
| the TA-axis | the TA-axis | the TA-axis | |
| 8.86 mm | 3.32 | 375 | KHz |
| 5.85 mm | 3.03 | 518 | KHz |
| 5.00 mm | 3.00 | 601 | KHz |
| 3.80 mm | 2.81 | 739 | KHz |
| 3.55 mm | 2.63 | 741 | KHZ |

It should also be noted that the value of the parameter “K” in direction of the TA-axis is smaller than that in direction of the L-axis.

Formation of the Piezoelectric Oscillation Crystal as a Natural Tourmaline Oscillation Crystal from a Tourmaline Raw Crystal with a Trigonal or Hexagonal Structure and an Oscillation Direction Along a TS-Axis

Preferably, the electrodes can be arranged at surfaces of the tourmaline oscillation crystal, which are perpendicular to a TS-axis and run parallel to the L-axis. In this case, the oscillation direction of a piezoelectrically excited oscillation of the tourmaline oscillation crystal runs along a TS-axis. Furthermore, the electrodes are here advantageously parallel to the TA-axis.

An oscillation direction along a TS-axis is advantageous, because the piezoelectric oscillation crystal in direction of the TS-axis has the greatest piezoelectric activity and causes the lowest cutting waste. Furthermore, the value of the parameter “K” of the TS-axis orientation is the smallest compared with that in direction of the L-axis or a TA-axis.

A high piezoelectric activity of an oscillation crystal in direction of a TS-axis means that the oscillation crystal oscillates more strongly in this axis orientation. This is of fundamental importance in the long term. This is because, when the oscillation crystal oscillates more easily and more strongly, less current is required to make it oscillate. An oscillator circuit that is set up to make the oscillation crystal oscillate requires less effort for this purpose. Saving power means that less effort by “energy harvesting” needs to be made if the watch is to be operated without batteries, or that the batteries will have a much longer life cycle, if the watch is to be run with batteries.

With reference to the aspect of cutting waste, a tourmaline raw crystal with an oscillation direction of the tourmaline oscillation crystal to be achieved along a TS-axis can in particular be cut with a ratio of raw weight to cut weight of about 2:1. On the other hand, for all other orientations of the oscillation of the tourmaline oscillation crystal, the ratio of raw weight to cut weight can be at least 5:1 or even less favorable. Thus, an oscillation direction of the tourmaline oscillation crystal along a TS-axis brings a great financial advantage.

The low value of the parameter “K” is primarily crucial because this value goes down up to 2.0 at high frequencies, such as e.g., the frequency 888888 Hz. Thereby, in the case of a thickness of around 2 mm or even slightly less, a tourmaline oscillation crystal can be cut with an oscillation frequency of 888888 Hz or 1 MHz. So-called “tourmaline needles” (tourmaline needles) can therefore be used. “Tourmaline needles” are very slim tourmaline rods with a thickness of less than 3.5 mm, usually less than 3.0 mm. Such tourmaline rods cost only 5% per gram on the market compared with the price of normal tourmaline raw crystals. If the extremely favorable price for the raw material of “tourmaline needles” is calculated in combination with the low weight loss by cutting, a tourmaline oscillation crystal from “tourmaline needles” costs less than 1% of what a tourmaline oscillation crystal from normal tourmaline raw crystals, e.g., cut according to the L-axis, would cost.

It should be noted that the parameter “K” in direction of the TS-axis in the above formula for determining the oscillation frequency depending on the thickness of the tourmaline oscillation crystal in direction of the TS-axis is dependent on the thickness of the tourmaline oscillation crystal in direction of the TS-axis.

In order to represent this behavior of the tourmaline oscillation crystals also arithmetically, exemplary values of the parameter “K” of a typical Brazilian tourmaline oscillation crystal in direction of the TS-axis depending on the thickness of the tourmaline oscillation crystal in direction of the TS-axis as well as the corresponding values of the oscillation frequency are indicated in the following table

| | | Oscillation |
|---|---|---|
| Thickness of the | Parameter “K” of the | frequency of the |
| tourmaline oscillation | tourmaline oscillation | tourmaline oscillation |
| crystal in direction of | crystal in direction of | crystal in direction of |
| the TS axis | the TS axis | the TS axis |
| 3.98 mm | 2.63 | 663 KHz |
| 3.05 mm | 2.55 | 835 KHz |
| 2.50 mm | 2.20 | 778 KHz |
| 2.10 mm | 1.95 | 930 KHz |

For the TS-axis, the value of the parameter “K” is even lower than for the TA-axis and drops rapidly for thinner tourmaline panes.

In a tourmaline oscillation crystal with an oscillation direction along the TS-axis, the tourmaline oscillation crystal can preferably have pavilion facets that are inclined towards a TA-axis. Preferably, a pavilion angle is between 40 degrees and 50 degrees, and preferably at least 42 degrees.

For adding pavilion facets to the bottom side of the tourmaline oscillation crystal, the trigonal form of the tourmaline raw crystal can be optimally used in the case of a tourmaline oscillation crystal from a tourmaline raw crystal with a trigonal structure.

### Dependence of the Parameter “K” in Direction of a TA-Axis and a TS-Axis on the Thickness in the Direction of the Other Two Axes

Another surprising phenomenon is that the value of the parameter “K” in direction of the TA-axis and the value of the parameter “K” in direction of the TS-axis depends not only on the thickness of the respective tourmaline oscillation crystal in the respective orientation, but also on the thickness of the tourmaline oscillation crystal in direction of the other respective two axes. This means in other words that the value of the parameter “K” in direction of the TA-axis depends not only on the thickness of the tourmaline oscillation crystal in direction of the TA-axis, as described above, but also on the thickness of the tourmaline oscillation crystal in direction of the L-axis and a TS-axis. Correspondingly, the value of the parameter “K” in direction of the TS-axis depends not only on the thickness of the tourmaline oscillation crystal in direction of the TS-axis, as described above, but also on the thickness of the tourmaline oscillation crystal in direction of the L-axis and a TA-axis.

An arithmetic example is described below in order to illustrate this behavior of a tourmaline oscillation crystal.

Let us assume that the oscillation crystal has a thickness of 3.05 mm in direction of the TS-axis, a value for the parameter “K” of 2.55 in direction of the TS-axis and thus an oscillation frequency of 835 KHz in direction of the TS-axis. The thickness of the oscillation crystal in direction of the L-axis is, for example, 5 mm. When the thickness in direction of the L-axis is now reduced from 5 mm to 4 mm, while the thicknesses of the oscillation crystal in direction of the TA-axis and in direction of the TS-axis are left untouched, the oscillation frequency of the oscillation crystal in direction of the TS-axis approximately from 835 KHz to 855 KHz (or to another similar value, depending on the individual tourmaline). This means that for the same thickness in direction of the TS-axis of 3.05 mm, the tourmaline oscillation crystal has a higher oscillation frequency of 855 KHz and a value for the parameter “K” of 2.61.

By reducing the thickness in the L-axis direction, the oscillation frequency and the value of the parameter “K” in direction of the TA-axis and in direction of the TS-axis can be changed by up to 10%.

Finding the dependency of the parameter “K” in direction of a TA-axis and a TS-axis and thus also of the oscillation frequency in the respective orientation on the thickness in the direction of the other two axes is very advantageous, because the formation of a tourmaline oscillation crystal with a predetermined oscillation frequency along one of these axes from a tourmaline raw crystal can thus be carried out by changing the thickness of the tourmaline raw crystal in the other two axes.

This can be particularly advantageous, if a tourmaline oscillation crystal with an oscillation direction along the TA-axis should be provided.

In order to be able to accurately cut the TS-facets in such an oscillation crystal, it is best to cut the facets of the TA-orientation firstly. Then, the TS facets can be placed perpendicular to the TA-facets. In order, however, to achieve a fine tuning of the oscillation frequency of the tourmaline oscillation crystal, in particular when the electrodes are to be placed on the tourmaline oscillation crystal, it is of great advantage, if the final rest of the cutting can be performed while the electrodes are already placed (even if only temporarily) and the oscillation frequency can be measured during the cutting.

However, the TA-facets cannot be cut while the electrodes are already placed on the TA-facets. In such a case, the electrodes would be cut off again.

In order to solve this problem, the TA-facets can first be pre-cut, for example up to 4% or 5% accuracy, and the electrodes can be arranged, in particular attached, on the TA-facets. The frequency tuning can be carried out by cutting the remaining facets, especially the TS-facets.

This means, for example, that, if the oscillation frequency of 888888 Hz in direction of the TA-axis is to be achieved, the tourmaline raw crystal is first cut in such a way that it has an oscillation frequency of approximately 880000 Hz in direction of the TA-axis. Then, the electrodes are arranged, in particular attached, on the TA-facets, to measure the oscillation crystal during further cutting. The TS-facets are then cut, which are perpendicular to the TA-facets and run parallel to the L-axis. While the TS-facets are being cut, a piezoelectrically excited oscillation is constantly measured in the TA-orientation. As soon as the oscillation frequency of 888888 Hz is reached, the cutting process is stopped. When attaching the electrodes to the oscillation crystal, the described method of attaching the electrodes is all the more important as the attaching of the electrodes itself changes the frequency again. Normally, the frequency decreases when attaching the electrodes. In order to obtain a completely accurate frequency as result, when cutting a tourmaline, the electrodes must therefore in any case have been arranged, in particular attached, before the final polish-grinding.

Otherwise, the crystal would have to be removed, in particular puttied off, from the cutting holder in each intermediate check as to whether the desired oscillation frequency has been reached, because the tourmaline raw crystal is normally puttied on the grinding pin with putty for cutting a tourmaline raw crystal. The crystal would then have to be cleaned, measured with the oscilloscope, puttied on again and the grinding pliers clamped. Furthermore, the old facet would also have to be readjusted on the grinding disc before the cutting process could continue. This would result in a time loss of approx. one hour per intermediate check. In order to grind out a desired oscillation frequency that is accurate to 1 Hz, at least twenty intermediate checks are necessary, because the tourmaline cannot be calculated via its geometry. Each tourmaline raw crystal has a certain variation in its K values. Therefore, it is not possible to operate with the thickness of the grinding plate as a reference for the oscillation frequency.

Formation of the Piezoelectric Oscillation Crystal as a Natural Tourmaline Oscillation Crystal from a Tourmaline Raw Crystal with a Trigonal or Hexagonal Structure and an Oscillation Direction that is at an Angle Between 40 Degrees and 50 Degrees to the L-Axis

All oscillation crystals, regardless of the material, have the problem that their oscillation frequency changes as soon as their temperature changes. This is unavoidable because the speed of sound changes with the temperature of the resonating medium. The speed of sound is usually higher in cold tourmaline oscillation crystals than in warm tourmaline oscillation crystals. Therefore, the frequency of tourmaline oscillation crystals decreases when the temperature increases.

Thus, the accuracy of a watch, the timing of which is derived from a piezoelectric oscillation crystal, depends on how much the oscillation frequency fluctuates with a change in temperature.

Correcting a temperature-induced oscillation frequency change is possible by means of a correction mechanism. However, depending on the material of the piezoelectric oscillation crystal, the correction process can be complex and associated with a high current consumption.

For stabilizing the oscillation frequency of the tourmaline oscillation crystal independently from a temperature change without the need for a correction mechanism, a design is proposed, in which the electrodes are arranged at specific surfaces of the tourmaline oscillation crystal. These specific surfaces each have one edge, which is at an angle of 40 degrees to 50 degrees, preferably 45 degrees, to the L-axis, and each have another edge parallel to a TA-axis or a TS-axis. In other words, the electrodes are arranged in such a way that the surfaces provided for this purpose are inclined with one edge at an angle of 40 degrees to 50 degrees, preferably 45 degrees, to the L-axis, and run with the other edge parallel to a TS-axis or a TA-axis.

That is, the oscillation direction of the piezoelectrically excited oscillation of the tourmaline oscillation crystal deviates from the three related axes of the tourmaline oscillation crystal, i.e., the L-axis, the TA-axis, and the TS-axis, and makes use of a polarity that lies between the L-axis and the TA-axis, and accordingly between the L-axis and the TS-axis.

Preferably, the tourmaline oscillation crystal can have a table facet. Preferably, the table facet has an edge, which is at an angle of 40 degrees to 50 degrees, preferably 45 degrees, to the L-axis and another edge, which is parallel to a TA-axis or a TS-axis.

Preferably, the tourmaline oscillation crystal can have pavilion facets, which are inclined towards a normal vector of a table facet of the piezoelectric oscillation crystal. In particular, a pavilion angle can be between 40 degrees and 50 degrees, and preferably at least 42 degrees. Alternatively, the piezoelectric oscillation crystal can preferably have at its bottom side a plurality of facets, which are inclined towards a normal vector of a table facet of the piezoelectric oscillation crystal and form a plurality of protrusions. Here, the protrusions are arranged such that the protrusions form a corrugated profile. The facets of a respective protrusion are preferably at an angle to a plane that is parallel to a table facet of the tourmaline oscillation crystal, wherein the angle is between 40 degrees and 50 degrees, and preferably at least 42 degrees.

Within the scope of the invention, it was surprisingly found that this orientation, which does not follow any of the three polar axes of the tourmaline oscillation crystal, has a piezoelectric activity of 40% to 50% of that of the TS-axis, and is usually twice as strong as that of the L-axis.

In particular, the precision of a watch with a tourmaline oscillation crystal having such an oscillation direction is generally 3 times higher, and in particular cases up to 10 times higher, than the precision of a watch with a tourmaline oscillation crystal having an oscillation direction along its L-axis, a TA-axis or a TS-axis.

Dependency of the Parameter “K” in a Direction that is at an Angle of Between 40 Degrees and 50 Degrees, in Particular 45 Degrees, to the L-Axis on the Dimension of the Tourmaline Oscillation Crystal in the Direction of the L-Axis, a TA-Axis and a TS-Axis

In the following table, exemplary values of the parameter “K” of a tourmaline oscillation crystal in a direction, which is at an angle of 45 degrees to the L-axis, are indicated from the size of the tourmaline oscillation crystal in the direction of the L-axis, a TA-axis and a TS-axis as well as the corresponding values of the oscillation frequency.

| | | | Oscillation | | | | | |
|---|---|---|---|---|---|---|---|---|
| Thickness | | Parameter | frequency of | | | | | |
| of the | | “K” of the | the | Dimension | Dimension | | Dimension | |
| tourmaline | | tourmaline | tourmaline | of the | of the | | of the | |
| oscillation | | oscillation | oscillation | tourmaline | tourmaline | | tourmaline | |
| crystal in | | crystal in | crystal in | oscillation | oscillation | | oscillation | |
| direction of | | direction of | direction of | crystal in | crystal in | | crystal in | |
| 45 degrees | | 45 degrees | 45 degrees | direction of | direction of | | direction of | |
| to the L-axis | | to the L-axis | to the L-axis | the TS axis | the TA axis | | the L axis | |
| 3.2 | mm | 3.20 | 998 KHz | 3.9 mm | 3.5 | mm | 6.4 | mm |
| 3.2 | mm | 3.26 | 1019 KHz | 3.9 mm | 3.5 | mm | 5.85 | mm |
| 3.1 | mm | 3.26 | 1051 KHz | 3.5 mm | 3.3 | mm | 5.95 | mm |
| 3.1 | mm | 3.26 | 1057 KHz | 3.5 mm | 2.9 | mm | 5.95 | mm |
| 3.15 | mm | 3.30 | 1049 KHz | 3.5 mm | 3.25 | mm | 6.0 | mm |
| 3.15 | mm | 3.56 | 1150 KHz | 2.8 mm | 3.25 | mm | 6.0 | mm |
| 3.2 | mm | 3.23 | 1009 KHz | 3.8 mm | 3.2 | mm | 6.3 | mm |
| 3.6 | mm | 3.68 | 1023 KHz | 2.85 mm | 3.15 | mm | 6.0 | mm |

As can be seen from the table, the value of the parameter “K” of the tourmaline oscillation crystal in a direction that is at an angle of 45 degrees to the L-axis changes the most by reducing the dimension of the tourmaline oscillation crystal in direction of the TS-axis. A reduction from 3.5 mm on 2.8 mm increases the oscillation frequency of tourmaline oscillation crystal in the direction at an angle of 45 degrees to the L-axis by 10%.

In contrast, the oscillation frequency of the tourmaline oscillation crystal in the direction at an angle of 45 degrees to the L-axis hardly changes, when the dimension is reduced in direction of the TA-axis. In the case of a shortening of the tourmaline oscillation crystal in direction of the TA-axis from 3.3 mm on 2.9 mm, the oscillation frequency of tourmaline oscillation crystal in the direction at an angle of 45 degrees to the L-axis only increases by 0.5%.

In the case of a shortening of the tourmaline oscillation crystal in direction of the L-axis from 6.4 mm to 5.85 mm, the oscillation frequency of the tourmaline oscillation crystal in the direction at an angle of 45 degrees to the L-axis increases by 2%.

Formation of the Piezoelectric Oscillation Crystal as a Natural Tourmaline Oscillation Crystal from a Tourmaline Raw Crystal with an Alternative Structure to the Trigonal or Hexagonal Structure

According to a further advantageous design of the invention, the piezoelectric oscillation crystal can be a natural tourmaline oscillation crystal formed from a tourmaline raw crystal having a structure between a trigonal structure and a hexagonal structure or any other structure. This means that the tourmaline raw crystal has a cross-section between a triangle and a hexagon or another cross-section.

### Formation of the Piezoelectric Oscillation Crystal (Clock Generator) as Rubelite

According to a further advantageous design of the invention, a rubelite (rubelite crystal) is used as tourmaline. The rubelite is a special type of tourmaline. In particular, a rubelite is a variety of the mineral “elbaite” from the group of tourmalines.

A first advantage of rubelite is that it has a beautiful bright and strong red color, which sometimes looks like a ruby color. A rubelite is therefore well suited for a clock generator that also serves as a gemstone of the watch. A second advantage is that a rubelite does not have a “closed” optical-axis. This means that no attention needs to be paid to possible optical features, when cutting the rubelite. This leads to a simplification of the processing of a rubelite raw crystal for providing a rubelite oscillation crystal.

Designs of the Piezoelectric Oscillation Crystal (Clock Generator) with Regard to its Oscillation Frequency

Regardless of the oscillation direction and the material, from which the piezoelectric oscillation crystal is formed, the piezoelectric oscillation crystal can preferably have, in the oscillation direction of a piezoelectrically excited oscillation, an oscillation frequency, which is a value having only the number 8 or only the number 8 and the number 0. In other words, this means that the oscillation frequency has only the number 8 in the Hz region or KHz region. Preferably, the oscillation frequency is 8888 Hz, 88888 Hz, 888888 Hz, 8888888 Hz, 8 kHz, 88 KHz, 888 KHz or 8888 KHz.

This has the advantage that the oscillation frequency can in a simple manner be brought down to a frequency of 8 Hz, which is the ideal frequency for avoiding a jump or at least a visible jump of a second hand of a mechanical watch display device of the watch.

Furthermore, such an oscillation frequency can be used as a standard frequency for a watch with a piezoelectric oscillation crystal formed as a tourmaline oscillation crystal. Thus, standard electronics can also be provided for all applications. Otherwise, when a different oscillation frequency would be used for each different application of the tourmaline oscillation crystal in the watch, the electronics of the watch would either have to be completely redesigned for that new application, or at least a programmable chip would have to be used, which is programmed to each individual oscillation frequency depending on the application of the tourmaline oscillation crystal. It is understood from the preceding description that the oscillation frequency proposed herein, which is a value having only the number 8 or only the numbers 8 and 0, proves to be the ideal oscillation frequency for multiple applications of the tourmaline oscillation crystal. For example, such an oscillation frequency for the tourmaline oscillation crystal can be used, when the tourmaline oscillation crystal serves not only as a clock generator but also as a gemstone of the watch, in particular in a wristwatch, or when a watch with an oscillation crystal with a high oscillation frequency is desired that runs particularly precisely.

For achieving an oscillation frequency with a value having only the number 8 in the Hz region or in the KHz region, a raw oscillation crystal is in an advantageous manner cut to the desired oscillation frequency. A tourmaline raw crystal that is cut to an oscillation frequency of 888888 Hz or 888 KHz is best suited for this purpose. The reasons for this are as follows:

One can halve the oscillation frequency of 888888 Hz three times in a first step with a frequency divider. Thus, in a second step, only the frequency (intermediate frequency) of 111111 Hz resulting from the threefold division has to be counted down with a pulse counter in order to arrive at the frequency of 1 Hz. The combination of a frequency division and a counting down to obtain the frequency of 1 Hz saves power, because the counting activity is reduced to one eighth by the pulse counter due to the frequency division. In the case of an oscillation frequency of 888 KHz, i.e., 888000 Hz, the frequency can even be brought up to the frequency of 13875 Hz by successively halving it 6 times, in order to then count it down to a frequency of 1 Hz or a frequency between 1 Hz and 10 Hz by means of a pulse counter.

In general, the procedure of halving, in particular multiple halving, the oscillation frequency in a first step to reach an intermediate frequency and counting down the intermediate frequency to a desired frequency is particularly advantageous for piezoelectric oscillation crystals with a high oscillation frequency, such as e.g., 8.88 MHz or 10 MHz, in order to current compared with a simple down-counting of the oscillation frequency.

Within the scope of the invention, the desired frequency can also be characterized as a useful frequency.

If one wishes to avoid the second jump or at least a visible second jump of the second hand of a mechanical watch display device of the watch, then one can bring down the oscillation frequency 888888 Hz to 8 Hz by means of a pulse counter. The frequency of 8 Hz is the ideal useful signal frequency for an invisibly jumping second hand. In addition, one can bring the frequency of 8 Hz down to 1 Hz by halving it three times. Depending on the type of gear train, this facilitates the transmission in the gear train of the watch.

An oscillation frequency of 888888 Hz or 888 KHz results in a tourmaline oscillation crystal, which, when cut in a TS-axis, is a plate with a thickness of approx. 2 mm. The exact thickness varies depending on the type of tourmaline and the size of the plate. This thickness is easy to be processed. This thickness is ideal for tourmaline oscillation crystals that are in particular not optically used. The tourmaline is also solid enough here to avoid long-term ageing.

The frequency of 888888 Hz and 888 KHz, when cut in direction of the L-axis, results in a size for the tourmaline oscillation crystal that is ideal for a wristwatch. The thickness in direction of the L-axis is then about 4.3 mm, which is an ideal size for a visible tourmaline oscillation crystal.

According to an advantageous embodiment of the invention, the piezoelectric oscillation crystal can be a tourmaline oscillation crystal, wherein the oscillation frequency is 888888 Hz or 888 kHz, the length, the width and the height of the piezoelectric oscillation crystal are each 8.88 mm, and the piezoelectric oscillation crystal weighs 8.88 carats. This means in other words that, when a tourmaline raw crystal is cut to an oscillation frequency of 888888 Hz or 888 Hz, the tourmaline oscillation crystal has only one number in all respects, namely the number 8, or only the number 8 and the number 0. Namely, this tourmaline oscillation crystal is 8.88 mm in length, 8.88 mm in width, 8.88 mm in height, weighs 8.88 carats and oscillates with an oscillation frequency of 888888 Hz or 888 KHz. This combination cannot be achieved with any other oscillation frequency. For example, it would not be possible to find a tourmaline oscillation crystal that is 6.66 mm long, 6.66 mm wide, 6.66 mm high and that it weighs at the same time 6.66 carats. Or there would not be a tourmaline oscillation crystal, the length, width and height of which are each 9.99 mm and which weighs 9.99 carats. So if one wants to cut a very special jewel (e.g. for a valuable desk clock), then an oscillation frequency of 888888 Hz or 888 KHz is the only one that allows the size and weight of the tourmaline oscillation crystal to have only the number 8.

Preferably, the piezoelectric oscillation crystal has an oscillation frequency in the oscillation direction of a piezoelectrically excited oscillation, which can be brought to a desired frequency, in particular of 1 Hz or 8 Hz, by multiple halving. In other words, the oscillation frequency is preferably a multiple of two. The watch advantageously has for this purpose a frequency divider, which is set up to bring the oscillation frequency of the clock generator to the desired frequency, in particular 1 Hz or 8 Hz. This means that the desired frequency can be achieved in a simple manner. In the case of a desired frequency of 1 Hz, a second hand of a mechanical watch display device of the watch can be moved in seconds. At a desired frequency of 8 Hz, the second hand of the watch does not make a small jump every second, but glides smoothly via the dial, as already described. This improves the main visual impression of the watch, because the second jump of the second hand is eliminated or at least not visible to the observer of the watch.

When for example the oscillation frequency of the piezoelectric oscillation crystal is 32768 Hz and the desired frequency is equal to 1 Hz, the oscillation frequency must be halved 15 times by the frequency divider. When the desired frequency is 8 Hz, the oscillation frequency must be halved 12 times by the frequency divider.

Preferably, the watch further comprises an oscillator circuit set up to excite the piezoelectric oscillation crystal to oscillate. In this case, an excitation frequency is preferably under the natural frequency of the piezoelectric oscillation crystal. This prevents the oscillation from collapsing, when the natural frequency shifts slightly (e.g., due to a temperature change). The oscillator circuit is advantageously part of the clock generator arrangement.

According to an advantageous design of the invention, the oscillator circuit preferably comprises a trimming capacitor, particularly preferably a capacitance diode, for adjusting the oscillation frequency of the piezoelectric oscillation crystal by adjusting a capacitance of the trimming capacitor, particularly preferably of the capacitance diode, using an electrical signal.

In this case, a control unit is preferably set up to adjust the electrical signal depending on a temperature of the clock generator and/or a temperature of the watch in the surroundings of the clock generator. For this purpose, a register with temperature-dependent values for the electrical signal (predetermined values for the electrical signal that are assigned to temperatures) and/or a function of a value of the electrical signal depending on the temperature can preferably be stored in a memory unit.

It should be noted in particular that this design of the oscillator circuit for temperature compensation can also be used in connection with piezoelectric oscillation crystals, which do not have a length, a width and a height each of at least 1 mm, preferably of at least 1.5 mm.

The current required to drive the oscillator circuit of the piezoelectric oscillation crystal can in an advantageous manner be provided from a rechargeable battery, which can preferably be charged by an energy harvesting device. The energy harvesting device can preferably comprise one or multiple solar cells.

When the watch is formed as a wristwatch, the energy harvesting device can preferably comprise at least one thermocouple (preferably a Peltier element) and/or at least one solar cell. The energy harvesting device is in an advantageous manner placed in the watch. For example, the dial can be prepared as a solar cell, or a solar cell can be arranged under a semi-transparent dial. The thermocouple can, for example, be attached to the bottom of the watch case, where it generates electricity from the difference between the temperature of the skin and the temperature of the surroundings of the watch (and thus the temperature of the rest of the watch). The solar cell(s) and thermocouples can also be built into the wristband of the watch. For example, it is possible to use textiles that function as thermocouples. Such a textile wristband could, for example, supply the power for the rechargeable battery.

Design of the Watch as a Mechanical Watch, i.e., a Watch with a Mechanical Clockwork

According to an advantageous design of the watch, the watch further comprises a gear train. In this case, the clock generator arrangement further comprises an electromechanical device. The electromechanical device is movable using a useful signal based on the oscillation frequency of the piezoelectric oscillation crystal, whereby the electromechanical device directly or indirectly engages with the gear train in a clocked manner. In particular, the electromechanical device engages directly or indirectly with the gear train in an inhibiting manner to alternately bring the gear train to a standstill and release it again. The watch is thus not timed in its gear speed by an oscillating balance wheel, but via a frequency-controlled device (the electromechanical device), wherein the drive energy for the gear train is provided by a mechanical drive device. In other words, the inaccurate mechanical balance wheel is replaced by the clock generator arrangement described above.

Thus, the advantages of a hand-winding or self-winding mechanical watch and a quartz watch are realized in one watch by controlling an automatic work or a hand-winding mechanical work by the electronic frequency of a clock generator. In this case, the clock generator can be based on a piezoelectric oscillation crystal. However, it can also be about an oscillation system, in which the frequency-determining unit is not a simple oscillation crystal, but another mechanism, such as an optic fiber or an oscillator on any arbitrary basis. Because no balance wheel is provided in the proposed watch, all mechanical influences that affect the clocking of the balance wheel and thus the accuracy of the time flow of the watch are eliminated here. The reference frequency used to clock the watch, which corresponds to the oscillation frequency of the clock generator, is not influenced by a movement of the wearer of the watch. This enables a mechanical watch in terms of driving the gear train that is much more precise than a conventional mechanical watch with a balance wheel.

Because the electromechanical device is movable using the useful signal and the useful signal can be generated based on the oscillation frequency of the clock generator, it is to be understood that the electromechanical device is frequency controllable or rather frequency controlled.

According to one option, the electromechanical device engages indirectly with the gear train. “Indirectly” means within the scope of the present invention in particular that at least one further component is arranged between the electromechanical device and the gear train. This means that in this design of the watch, the electromechanical device is movable using the above-mentioned useful signal, whereby the electromechanical device indirectly engages with the gear train for inhibition.

Preferably, the watch comprises an escapement for this purpose. The escapement is in engagement with the gear train. The electromechanical device drives in this case the escapement. This means that in this design of the watch the electromechanical device is movable using the useful signal, whereby the electromechanical device engages with the gear train via the escapement. In other words, the escapement corresponds in this case to the above-mentioned at least one further component, which is arranged between the electromechanical device and the gear train.

Preferably, the escapement comprises an escapement wheel and an inhibition piece. The inhibition piece serves to inhibit the escapement wheel. Here, the electromechanical device is arranged to drive the inhibition piece, wherein the escapement wheel is in engagement with the gear train.

In particular, the escapement is formed as anchor escapement, wherein the inhibition piece is formed as an anchor. Here, the escapement wheel can also be characterized as an anchor wheel.

According to an alternative advantageous design of the invention, the electromechanical device can engage directly/immediately with in the gear train. “Directly” or “immediately” means within the scope of the present invention in particular that no other component is arranged between the electromechanical device and the gear train. This means that in this design of the watch the electromechanical device is movable using the above-mentioned useful signal, whereby the electromechanical device engages directly with the gear train in a clocked manner.

Irrespective of whether the electromechanical device engages directly or indirectly with the gear train, the electromechanical device can be formed as an actuator according to an advantageous embodiment of the invention. Within the scope of the present invention, a driving device or component that converts an electrical signal into a mechanical move is characterized as an actuator.

Particularly preferably, the actuator can have a magnetic armature and a magnetic coil. Here, the magnetic coil is set up to move the magnetic armature using the useful signal.

Alternatively, the electromechanical device can preferably be formed as a stepper motor. In this design of the electromechanical device, it is particularly advantageous, when the electromechanical device engages directly with the gear train in a clocked manner.

For generating the above-mentioned useful signal, the clock generator arrangement can advantageously comprise an electronic useful signal generating device comprising (only) a pulse counter. The pulse counter is advantageously programmed on the predetermined oscillation frequency of the clock generator. The pulse counter is preferably designed for counting a clock signal of the clock generator or a signal based on a clock signal of the clock generator. The useful signal generating device is set up to generate the useful signal, when a count value of the counted clock signal of the clock generator or the counted signal based on the clock signal of the clock generator is equal to a predetermined count value.

Preferably, the watch comprises a control unit that is set up to correct the predetermined count value depending on a temperature of the clock generator and/or a temperature of the watch in the surroundings of the clock generator. For this purpose, a register with temperature-dependent predetermined count values (predetermined count values that are assigned to temperatures) and/or a function of the predetermined count value depending on the temperature can preferably be stored in a memory unit.

For providing the piezoelectric oscillation crystal, a raw oscillation crystal can first be arbitrarily cut and its oscillation frequency measured. The pulse counter is then programmed on exactly this oscillation frequency, i.e., a predetermined count value of the pulse counter is set based on the measured oscillation frequency. However, it is also possible for the raw oscillation crystal to be cut to a predetermined oscillation frequency. In this case, the pulse counter is also programmed based on the predetermined oscillation frequency.

Furthermore, for generating the above-mentioned useful signal, the electronic useful signal generating device can advantageously comprise (only) a frequency divider. The frequency divider is set up to divide or rather halve the predetermined oscillation frequency of the clock generator. In particular, the predetermined oscillation frequency corresponds to a multiple of two, in particular a power of two, such as 524288 Hz or 1048576 Hz. The predetermined oscillation frequency can in this case be advantageously broken down to 1 Hz or another frequency, such as 8 Hz, using the frequency divider. The broken down oscillation frequency corresponds to the useful signal, using which the electromechanical device is movable. It should be noted that with a useful signal of e.g., 8 Hz, the jump of the second hand, which then occurs 8 times per second, is no longer perceived as a “jump” by the viewer.

The term “only” in use with the terms of the pulse counter or the frequency divider means in particular within the scope of the invention that only one of the two types of electronic components, i.e., either only a pulse counter or only a frequency divider, is provided in the useful signal generating device in order to generate the useful signal based on the predetermined oscillation frequency of the clock generator.

However, a combination of a frequency divider with a pulse counter is also possible for generating the useful signal. In other words, this means that the electronic useful signal generating device can comprise both a frequency divider and a pulse counter for generating the useful signal. In this case, the frequency divider is advantageously arranged in terms of signaling before the pulse counter. In an advantageous manner, the predetermined oscillation frequency of the clock generator can be halved, in particular halved several times, in a first step to achieve an intermediate frequency by the frequency divider. In a second step, the intermediate frequency can be brought to a desired frequency or rather a useful frequency. The procedure of halving, in particular multiple halving, the predetermined oscillation frequency in a first step to reach an intermediate frequency and counting down the intermediate frequency to a desired frequency in a second step is particularly advantageous in a watch comprising a clock generator with a high oscillation frequency, such as 8.88 MHz or 10 MHz. Thus, current can be saved compared with a simple down-counting the oscillation frequency.

Furthermore, the clock generator arrangement can preferably comprise an output device. In the case of an electronic useful signal generating device comprising only a pulse counter, the output device is advantageously set up to output a useful signal, when a count value of the counted clock signal is equal to a predetermined count value. In the case of an electronic useful signal generating device comprising only a frequency divider, the output device is advantageously set up to output a useful signal based on an output signal of the frequency divider. In the case of an electronic useful signal generating device comprising a pulse counter and a frequency divider, the output device is advantageously set up to output a useful signal, when a count value of the counted clock signal of the clock generator is equal to a predetermined count value. Here, the predetermined count value is preferably set based on the intermediate frequency achieved by the frequency divider.

The watch can preferably be an automatic watch. An automatic watch is understood to be a mechanical wristwatch, in which a spring stores energy and converts it into a rotation movement of the hands of the watch. In particular, the spring is automatically wound (tensioned) in small steps by a rotor using a gear transmission, when the arm of the wearer moves. The watch is also referred to as an automatically winding or self-winding watch. Alternatively, the watch can be a mechanical watch with hand winding.

The electromechanical device is in this case preferably set up to move in such a way that the electromechanical device drives the gear train when the tension of the drive spring is exhausted. As a result, kinetic energy flows from the electromechanical device into the gear train and the electromechanical device drives the gear train. This reserve-drive using the electromechanical device takes place in a clocked manner, according to the useful signal. The watch can thus be given a long power reserve.

When the watch is formed as a self-winding watch, a device for decoupling the drive spring from the gear train and the escapement wheel is advantageously provided. As a result, it can be prevented that the drive spring is wound by the electromechanical device, when the electromechanical device drives the gear train.

In a watch comprising an escapement, the electromechanical device is preferably set up to move such that, when the tension of the drive spring is exhausted, the electromechanical device moves the escapement such that the escapement drives the gear train. In order to realize this in a watch with an escapement formed as an anchor escapement, it requires a well-balanced setting angle and design of the two tines of the anchor (inhibition piece) of the escapement and the setting angle and the form of the teeth of the escapement wheel.

When the electromechanical device is formed as a stepper motor, the stepper motor is preferably set up to move in such a way that, when the tension of the drive spring is exhausted, the stepper motor drives the gear train.

The use of the clock generator arrangement described above in an automatic watch instead of a balance wheel or of a balance wheel and an escapement results in an automatic watch that is much more precise than a normal automatic watch with a balance wheel and escapement. Furthermore, the current demand that must be provided by a current source, such as e.g., a rechargeable battery, a solar cell, a thermogenerator, or combinations thereof, can partially be reduced due to the automatic winding of the automatic watch.

The present invention further relates to a method of manufacturing a watch, in particular a wristwatch. The method comprises providing a clock generator arrangement that comprises a clock generator comprising a piezoelectric oscillation crystal and electrodes, and preferably inserting the clock generator arrangement in a watch case.

Preferably, the piezoelectric oscillation crystal has a length, a width and a height of respectively at least 1 mm, preferably at least 1.5 mm, further preferably at least 3 mm, particularly preferably at least 5 mm.

It should be noted that the features mentioned above with reference to the watch also relate to the method of manufacturing a watch. This means that these features can also be combined with the method for manufacturing a watch.

In an advantageous manner, the piezoelectric oscillation crystal has a predetermined oscillation frequency.

Furthermore, the method can comprise the following steps: providing a pulse counter set up to count a clock signal of the clock generator; providing an output device; storing a predetermined count value derivable from the predetermined oscillation frequency in a memory of the pulse counter or the output device; setting up the output device to output a useful signal, when a count value of the clock signal of the clock generator counted by the pulse counter is equal to the predetermined count value; and installing the clock generator, the pulse counter and the output device in the watch.

Preferably, the step of providing the clock generator arrangement comprises the steps of providing any arbitrary piezoelectric oscillation crystal, generating an oscillation of the piezoelectric oscillation crystal, and measuring the oscillating piezoelectric oscillation crystal using a frequency counter for determining its oscillation frequency. The measured oscillation frequency corresponds in this case to the predetermined oscillation frequency. Thus, any arbitrary piezoelectric oscillation crystal can be used, or rather a raw oscillation crystal can be arbitrarily processed for making a piezoelectric oscillation crystal, wherein its measured oscillation frequency is used as the predetermined oscillation frequency, from which the predetermined count value is derived.

According to an advantageous embodiment, the step of providing the clock generator arrangement comprises the steps of selecting an oscillation frequency as the predetermined oscillation frequency and of forming, in particular cutting or another forming method such as etching, or of refining by material removal using a laser, a piezoelectric oscillation crystal from a raw oscillation crystal such that the oscillation crystal has the predetermined oscillation frequency. In other words, a piezoelectric oscillation crystal is in an advantageous manner formed so that it has a deliberately selected oscillation frequency in its final form and not an arbitrary oscillation frequency.

Thus, the watch can be equipped with a clock generator arrangement for the clock generator of which a piezoelectric oscillation crystal with an oscillation frequency individualized according to the wishes of the owner of the watch, in particular the wearer of the watch in the case of a wristwatch, has been used. For example, the date of birth of the wearer of the wristwatch can be selected as the oscillation frequency of the piezoelectric oscillation crystal of the first clock generator.

A method of providing a tourmaline oscillation crystal with a predetermined oscillation frequency of a piezoelectrically excited oscillation in an oscillation direction along the L-axis, TA-axis, TS-axis or along a direction that has an inclination of 40 degrees to 50 degrees, in particular a 45 degree inclination, to the L-axis is further proposed. The method comprises the steps of cutting a tourmaline raw crystal in the oscillation direction of the tourmaline oscillation crystal, of arranging, in particular adding, electrodes at/to the tourmaline raw crystal, which are perpendicular to the oscillation direction, of measuring the tourmaline raw crystal in the oscillation direction, and of cutting, in particular while the electrodes are arranged, in particular added, the tourmaline raw crystal in direction of an axis from the group of the L-axis, TA-axis, TS-axis or in a direction, which is inclined between 40 degrees and 50 degrees, in particular 45 degrees, against the L-axis, which does not correspond to the oscillation direction, in particular during the measurement, until the predetermined oscillation frequency is reached.

Within the scope of the invention, the oscillation direction is in particular the direction of current flow through the piezoelectric oscillation crystal or, in other words, the direction of the excitation of an oscillation of the piezoelectric oscillation crystal by the current. When for example the electrodes are arranged at surfaces of a tourmaline oscillation crystal that are perpendicular to the L-axis of the tourmaline oscillation crystal, the current direction is parallel to the L-axis. In this case, the oscillation direction is therefore along the L-axis.

It should be noted that the headings included in the foregoing description are provided in particular to improve the readability of the text and are not limiting for the respective subsequent parts of the description.

### BRIEF DESCRIPTION OF THE DRAWINGS

Further details, features and advantages of the invention are derived from the following description and the figures of embodiments, wherein identical and accordingly functionally identical components are respectively designated with the same reference sign.

FIG. 1 a schematic simplified top view of a watch according to a first embodiment of the present invention,

FIG. 2 a schematic perspective view of a tourmaline raw crystal with a trigonal structure,

FIG. 3 a schematic perspective view of a tourmaline oscillation crystal according to the first embodiment of the invention,

FIG. 4 a schematic perspective view of a tourmaline raw crystal, from which the tourmaline oscillation crystal of FIG. 3 is formed,

FIG. 5 a schematic perspective view of a cutout of the tourmaline raw crystal of FIG. 4, from which the tourmaline oscillation crystal of FIG. 3 results after shaping,

FIG. 6 a schematic side view of the tourmaline oscillation crystal from FIG. 3 from the right,

FIG. 7 a schematic simplified top view of the watch according to the first embodiment of the present invention,

FIG. 8 a schematic simplified perspective view of a tourmaline oscillation crystal according to a second embodiment of the invention,

FIG. 9 a schematic simplified front view of the tourmaline oscillation crystal of FIG. 8,

FIG. 10 a schematic simplified top view of the tourmaline oscillation crystal of FIG. 8,

FIG. 11 a schematic perspective view of a tourmaline oscillation crystal according to a third embodiment of the invention,

FIG. 12 a schematic perspective view of a tourmaline raw crystal, from which the tourmaline oscillation crystal of FIG. 11 is formed,

FIG. 13 a schematic simplified front view of the tourmaline raw crystal of FIG. 12,

FIG. 14 a schematic perspective view of a tourmaline oscillation crystal according to a fourth embodiment of the invention,

FIG. 15 a schematic perspective view of a tourmaline raw crystal, from which the tourmaline oscillation crystal of FIG. 14 is formed,

FIG. 16 a schematic perspective view of a tourmaline oscillation crystal according to a fifth embodiment of the invention,

FIG. 17 a schematic perspective view of a tourmaline raw crystal, from which the tourmaline oscillation crystal of FIG. 16 is formed,

FIG. 18 a schematic perspective view of a tourmaline oscillation crystal according to a sixth embodiment of the invention,

FIG. 19 a schematic perspective view of a tourmaline raw crystal, from which the tourmaline oscillation crystal of FIG. 18 is formed,

FIG. 20 a schematic simplified top view of a watch according to a seventh embodiment of the present invention,

FIG. 21 a schematic simplified view of components of the watch according to the seventh embodiment of the present invention,

FIG. 22 a schematic simplified top view of a watch according to an eighth embodiment of the present invention,

FIG. 23 a schematic simplified view of components of the watch according to the eighth embodiment of the present invention,

FIG. 24 a schematic simplified view of a clock generator with a piezoelectric oscillation crystal and an electrode arrangement,

FIG. 25 a schematic simplified view of a clock generator arrangement of a watch according to the present invention, and

FIG. 26 a schematic simplified view of another clock generator arrangement of a watch according to the present invention.

### DETAILED DESCRIPTION

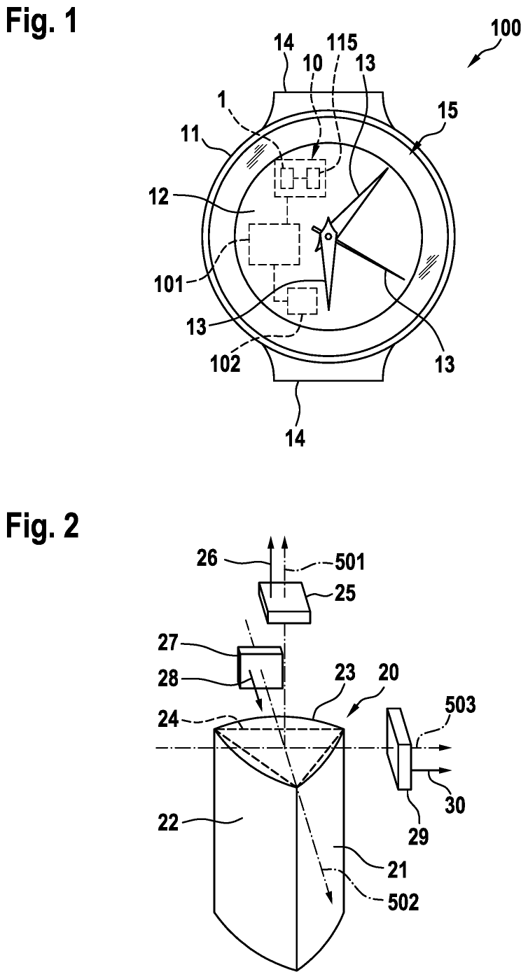

In the following, a watch 100 according to the present invention with a clock generator arrangement 10 according to a first embodiment of the present invention will be described in detail with reference to FIGS. 1 to 7.

As can be seen from FIG. 1, the watch 100 is formed as a wristwatch and thus has two connectors 14 for a wristband. However, it is also possible that the watch 100 is a wall clock, a grandfather clock or a clock of another type.

The watch 100 comprises a watch case 11 and a watch glass 15 arranged thereon. The watch 100 further has a dial 12 and three hands 13 for indicating the hours, minutes and seconds. The hands 13 are parts of a mechanical watch display device 102.

The clock generator arrangement 10 comprises a clock generator 1 comprising a piezoelectric oscillation crystal 2, and ensures that a useful signal is generated based on an oscillation frequency of the piezoelectric oscillation crystal 2. The useful signal can be received by a drive device 101 for moving the hands 13. The useful signal can also be characterized as a usage clock signal within the scope of the invention. How the useful signal can be generated will be explained in more detail later.

In order to make the piezoelectric oscillation crystal 2 oscillate, the clock generator arrangement 10 further comprises an oscillator circuit 115.

The drive device 101 comprises a drive element, which can be directly connected to the mechanical watch display device 102. Alternatively, the drive device 101 can comprise, in addition to the drive element, a translation device formed as a gear train, which connects the drive element to the mechanical watch display device 102 and translates a movement of the drive element into a movement of the mechanical watch display device 102. In particular, the drive element can be formed as an electric stepper motor, in particular a Lavet stepper motor, or another type of electromechanical drive.

It results further from FIG. 1 that the clock generator arrangement 10, the drive device 101 and the mechanical watch display device 102 are arranged in the watch case 11 under the dial 12.

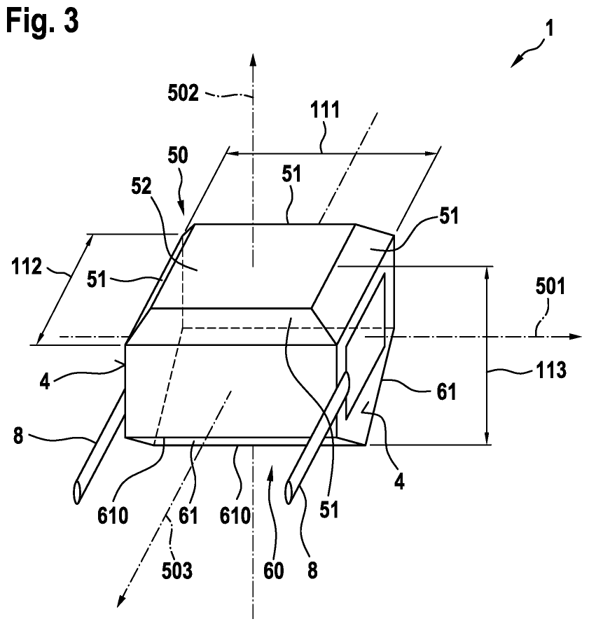

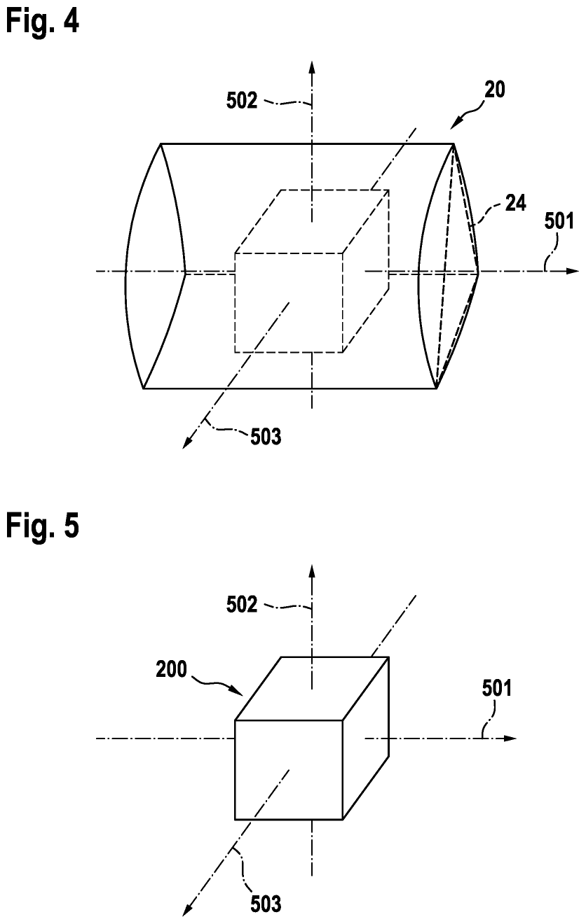

In this embodiment, the clock generator 1 comprises a piezoelectric oscillation crystal 2 formed as a tourmaline oscillation crystal (FIG. 3), which is made of a tourmaline raw crystal 20 according to FIG. 4.

First, the general structure of the tourmaline raw crystal 20 and its piezoelectric properties are explained with reference to FIG. 2.

In particular, it results further from FIG. 2 that the tourmaline raw crystal 20 has a trigonal structure. In other words, the tourmaline raw crystal 20 has crystallized trigonally, i.e., in a triangular form. The tourmaline raw crystal 20 has an L-axis 501, a TA-axis 502 (TA: Triangle-Angle) and a TS-axis 503 (TS: Tourmaline-side). The L-axis 501 corresponds to a first crystallographic axis, the TA-axis 502 to a second crystallographic axis and the TS-axis 503 to a third crystallographic axis 503.

In particular, the L-axis 501 corresponds to the crystallographic longitudinal axis of the tourmaline raw crystal 20. The TA-axis 502 is perpendicular to the L-axis 501 and passes through an angle formed between a first facet 21 and a second facet 22 of the tourmaline raw crystal 20. The TS-axis 503 of the tourmaline raw crystal 20 is perpendicular to the L-axis 501 and runs substantially parallel to the basic orientation of the slightly curved third facet 23 of the tourmaline raw crystal 20.

The tourmaline raw crystal 20 can be described by a structure triangle 24 or rather the cross-section of the tourmaline raw crystal 20 perpendicular to the L-axis 501 can be approximated by a structure triangle 24, the sides of which are associated with or rather follow the facets 21, 22, 23 of the tourmaline raw crystal 20. Thus, the L-axis 501 is perpendicular to the plane of the structure triangle 24, wherein the TA-axis 502 is perpendicular to the L-axis 501 and passes through an angle, which is formed between two of the three sides of the structure triangle 24. The TS-axis 503 is perpendicular to the L-axis 501 and runs parallel to one of the three sides of the structure triangle 24.

The L-axis 501, the TA-axis 502 and the TS-axis 503 are polar axes, so that the tourmaline raw crystal 20 has a piezoelectric activity along each of these axes. For illustrating this effect, a first tourmaline plate 25, a second tourmaline plate 27 and a third tourmaline plate 29 cut out from the tourmaline raw crystal 20 are shown in FIG. 2. In particular, the first tourmaline plate 25 is cut perpendicular to the L-axis 501, the second tourmaline plate 27 perpendicular to the TA-axis 502 and the third tourmaline plate 503 perpendicular to the TS-axis 503. Thus, the normal vector 26 of a main surface of the first tourmaline plate 25 is parallel to the first L-axis 501, the normal vector 28 of a main surface of the second tourmaline plate 27 is parallel to the TA-axis 502 and the normal vector 30 of a main surface of the third tourmaline plate 25 is parallel to the TS-axis 503.

When an electrical voltage is applied to the respective main surface and its opposite main surface of the tourmaline plates 25, 27, 29, the first tourmaline plate 25 will oscillate in direction of the L-axis 501, the second tourmaline plate 27 in direction of the TA-axis 502, and the third tourmaline plate 29 in direction of the TS-axis 503. Alternatively, a tourmaline plate can be cut out from the tourmaline raw crystal 20 at an angle of 45 degrees to the L-axis 501.

A piezoelectric activity of the tourmaline raw crystal 20 is the lowest in direction of the L-axis and the highest in direction of the TS-axis. A piezoelectric activity of the tourmaline raw crystal 20 in direction of the TA-axis is between that of the tourmaline oscillation crystal 20 in direction of the L-axis and the TS-axis.

From FIG. 3, which is a perspective view of the tourmaline oscillation crystal that functions as the clock generator 1 of the watch 100 in this embodiment, it can be seen that electrodes 8 are arranged at surfaces 4 of the tourmaline oscillation crystal that are perpendicular to the L-axis 501. That is, an oscillation direction of a piezoelectrically excited oscillation of the tourmaline oscillation crystal runs along the L-axis 501.

In an advantageous manner, the tourmaline oscillation crystal has a length 111, a width 112 and a height 113, which are respectively at least 1 mm, preferably at least 1.5 mm. Due to its dimensions, when an electrical voltage is applied to the electrodes 8, the tourmaline oscillation crystal can oscillate stably without the tourmaline oscillation crystal having to be in a vacuum. The dimensions of the tourmaline oscillation crystal further ensure that no or only a minimal aging of the tourmaline oscillation crystal takes place. Thus, the oscillation frequency of the tourmaline oscillation crystal remains unchanged over time or is only minimally affected, so that the accuracy of the watch 100 also remains basically unchanged.

It results further from FIG. 3 that the tourmaline oscillation crystal is formed as a faceted stone. In particular, the tourmaline oscillation crystal has a crown 50 and a pavilion 60. Crown facets 51 and a table facet 52 are formed in the crown 50, wherein pavilion facets 61 are formed in the pavilion 60. The table facet 52 is in this case perpendicular to the TA-axis 502. The pavilion facets 61 are inclined towards the TA-axis 502 and each have two edges 610, which run parallel to the L-axis 501.

For manufacturing the tourmaline oscillation crystal, a cuboidal part is first cut out from the tourmaline raw crystal 20 shown in FIG. 4. The cuboidal cutout 200, which can be seen in FIG. 5, is preferably cut in such a way that the crown 50 and the pavilion 60 of the tourmaline oscillation crystal according to FIG. 3 are formed.

In order for the tourmaline oscillation crystal to unfold its optical properties and serve as the gemstone 1 of the watch 100, the watch 100 has according to FIG. 7 a see-through region 114, through which the tourmaline oscillation crystal is visible. In this embodiment, the see-through region 114 comprises the watch glass 15 and an opening 120 in the dial 12. In particular, the tourmaline oscillation crystal is arranged under the opening 120, such that it is visible through the watch glass 15 and the opening 120 of the dial 12. In particular, the tourmaline oscillation crystal is positioned such that the crown 50 and accordingly the table facet 52 face the watch glass 15. A viewing window can be provided in the dial 12 at the position of the opening 120 according to a further development of the watch 100.

However, it is also possible to dispense with a dial in the watch 100. In this case, the see-through region 114 can comprise the watch glass 15. Here, the crown 50 and accordingly the table facet 52 preferably face the watch glass 15. According to an alternative design of the watch 100, the see-through region 114 can comprise a region of the watch case 11, in particular a watch case bottom, which is formed to be see-through.

Thus, a viewer of the watch can look directly on the table facet 51. In particular, a viewing direction of the viewer on the table facet 52 (perpendicular to the table facet 52) runs perpendicular to the L-axis 501 and parallel to the TA-axis 502 of the tourmaline oscillation crystal.

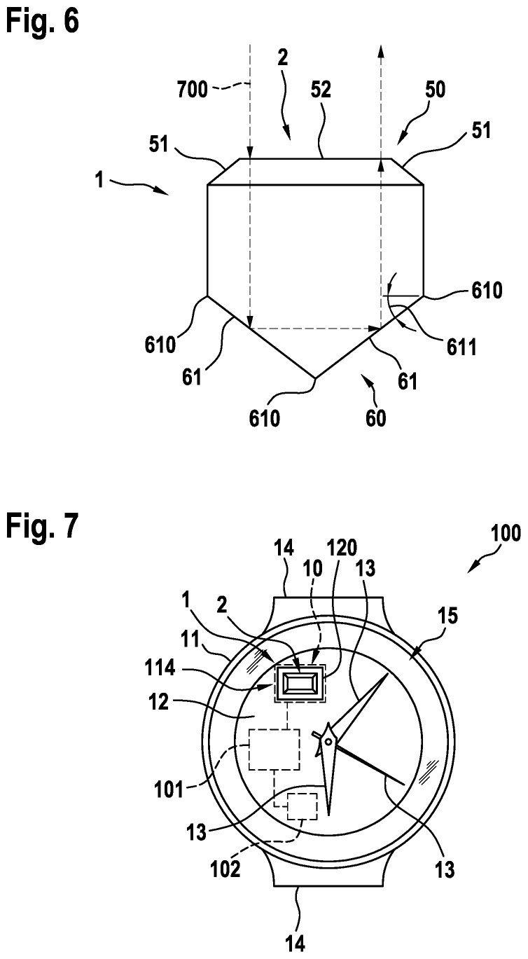

In order to achieve an increased sparkle of the tourmaline oscillation crystal, a pavilion angle 611 of the tourmaline oscillation crystal is 42 degrees according to FIG. 6. Thus, the pavilion angle 611 is selected such that a double total reflection of light occurs in the pavilion 60 of the tourmaline oscillation crystal.

For explaining this aspect, the light guidance in the tourmaline oscillation crystal is shown in FIG. 6 with arrow 700. Light entering the tourmaline oscillation crystal from above through the crown 50 or rather the table facet 52 is totally reflected at the inner sides of the pavilion facets 61 and leaves the tourmaline oscillation crystal again upwards through the crown 50 or rather the table facet 52.

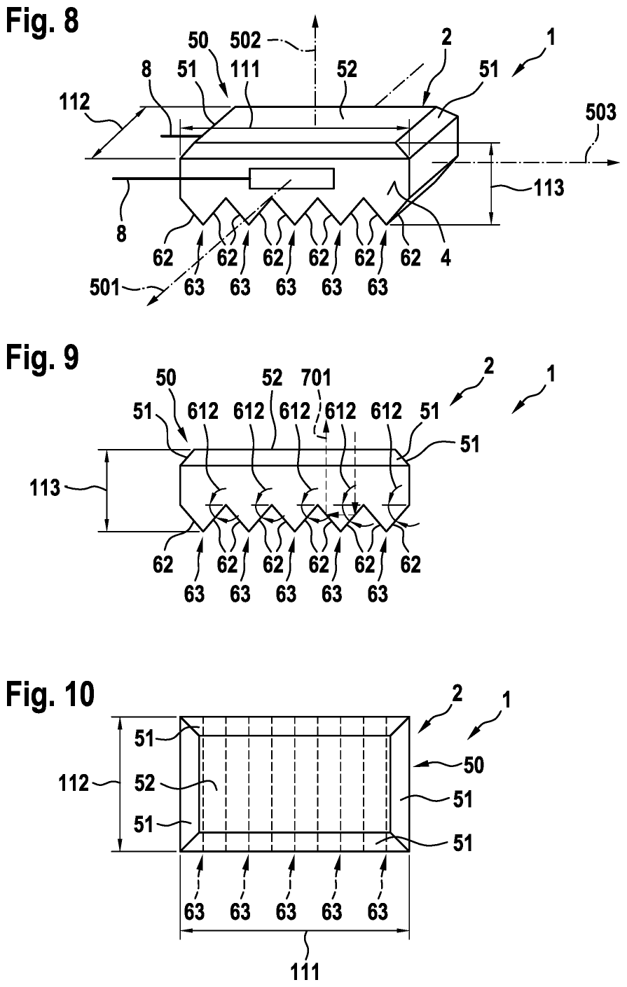

FIGS. 8, 9 and 10 refer to a clock generator 1 of a watch 100 according to a second embodiment of the present invention. FIG. 8 shows a perspective view of the clock generator 1, FIG. 9 a side view of the clock generator 1 and FIG. 10 a top view of the clock generator 1.

Like the clock generator 1 according to the first embodiment, the clock generator 1 according to the second embodiment also comprises a piezoelectric oscillation crystal 2 formed as a tourmaline oscillation crystal with electrodes 8 arranged thereon. The electrodes 8 are arranged at surfaces 4 of the tourmaline oscillation crystal, which are perpendicular to the L-axis 501. The table facet 52 of the tourmaline oscillation crystal is perpendicular to the TA-axis 502.

However, the tourmaline oscillation crystal according to the second embodiment differs from the tourmaline oscillation crystal according to the first embodiment in that the tourmaline oscillation crystal according to the second embodiment has at its bottom side a plurality of facets 62 that form a plurality of protrusions 63. In particular, two facets 62 that are inclined towards each other form a protrusion 63.

As can be derived from FIGS. 8 to 10, the protrusions 63 are arranged such that they form a corrugated profile, which extends in direction of the TS-axis 503. In this case, the protrusions 63 are arranged parallel to the L-axis 501. In particular, each protrusion 63 extends in direction of the L-axis 501.

Furthermore, according to FIG. 9, each facet 62 of the protrusions 63 is at an angle 612 to a plane parallel to the table facet 52, which enables a total reflection of light at the facets 62. In particular, the angle 612 is 42 degrees or greater. In other words, each facet 62 is inclined at an angle 612 of 42 degrees or greater towards the TA-axis 502, whereby double total reflection of light occurs in the tourmaline oscillation crystal.

In FIG. 9, for explaining this aspect, the guidance of light in the tourmaline oscillation crystal is illustrated by arrow 701. Light entering the tourmaline oscillation crystal from above through the crown 50 or rather the table facet 52, is totally reflected at the inner sides of the facets 62 of the protrusion 63 and leaves the tourmaline oscillation crystal again upwards through the crown 50 or rather the table facet 52.

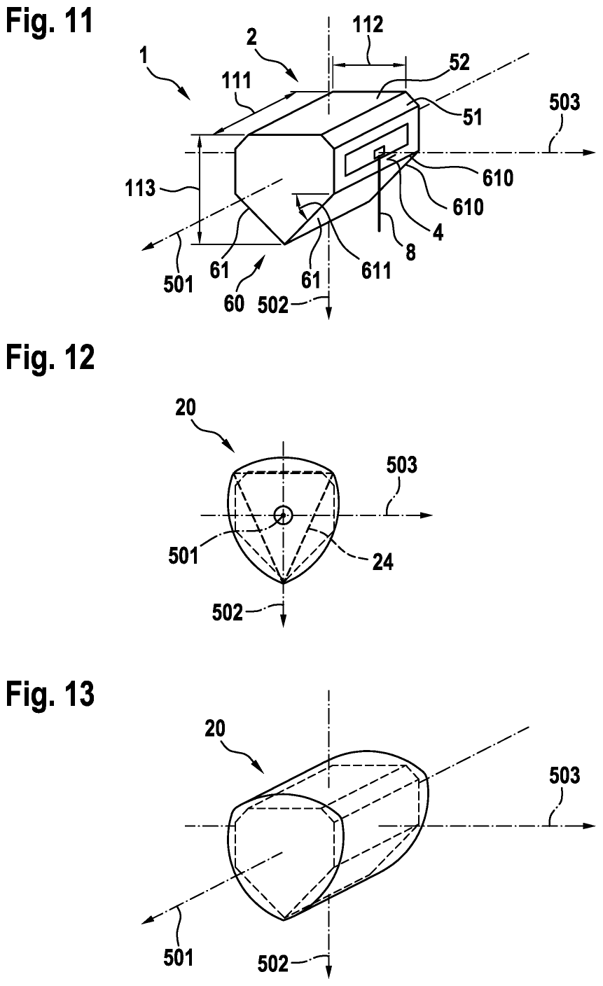

FIGS. 11, 12 and 13 refer to a clock generator 1 of a watch 100 according to a third embodiment of the present invention.

Like the clock generator 1 according to the first embodiment, the clock generator 1 according to the third embodiment comprises a piezoelectric oscillation crystal 2 formed as a tourmaline oscillation crystal with electrodes 8 arranged thereon.

However, in the tourmaline oscillation crystal according to the third embodiment, the electrodes 8 are arranged at surfaces 4, which are not perpendicular to the L-axis 501 as in the tourmaline oscillation crystal according to the first embodiment, but which run parallel to the L-axis 501 and are perpendicular to the TS-axis 503. Thus, the oscillation direction of a piezoelectrically excited oscillation of the piezoelectric oscillation crystal according to the third embodiment runs along the TS-axis 503.

Here, the table facet 52 of the tourmaline oscillation crystal is perpendicular to the TA-axis 502. The pavilion facets 61 are inclined towards the TA-axis 502 at an angle equal to the pavilion angle 611. In this case, the edges 610 of the pavilion facets 61 extend parallel to the L-axis 501.

For forming the tourmaline oscillation crystal according to the third embodiment, a tourmaline raw crystal 20 shown in FIG. 13 can be cut. The tourmaline raw crystal 20 preferably has the form of a tourmaline needle. The trigonal structure of the tourmaline raw crystal 20 can be optimally used for adding the pavilion facets 61 to the tourmaline raw crystal 20.

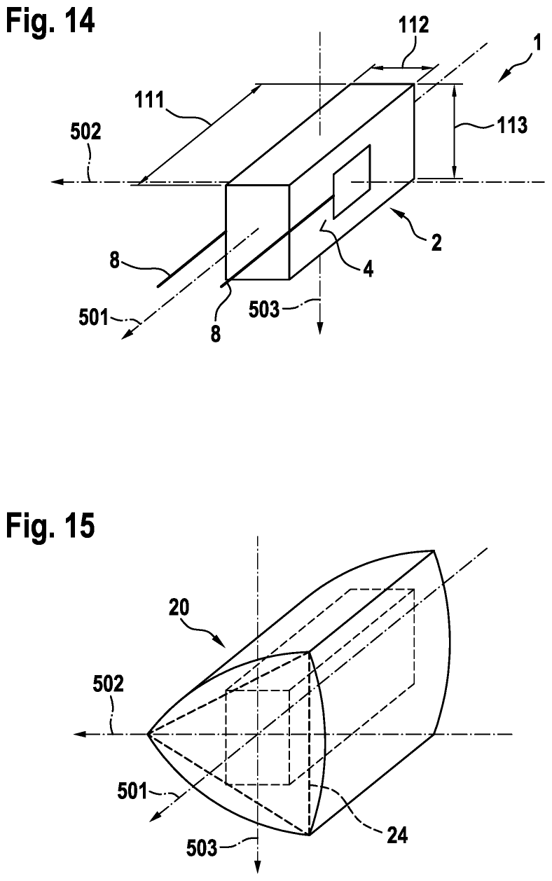

FIGS. 14 and 15 refer to a clock generator 1 of a watch 100 according to a fourth embodiment of the present invention.

Like the clock generator 1 according to the first embodiment, the clock generator 1 according to the fourth embodiment also comprises a piezoelectric oscillation crystal 2 formed as a tourmaline oscillation crystal with electrodes 8 arranged thereon.

However, the tourmaline oscillation crystal according to the fourth embodiment differs from the tourmaline oscillation crystal according to the first embodiment in that the tourmaline oscillation crystal according to the fourth embodiment comprises the electrodes 8 arranged at surfaces 4 of the tourmaline oscillation crystal, which are perpendicular to the TA-axis 502 and run parallel to the L-axis 501. Here, an oscillation direction of a piezoelectrically excited oscillation of the tourmaline oscillation crystal is along the TA-axis 502.

Another difference between the tourmaline oscillation crystal according to the fourth embodiment and the tourmaline oscillation crystal according to the first embodiment is that the tourmaline oscillation crystal according to the fourth embodiment does not have a faceted pavilion that would be capable of reflecting incident light. Thus, the tourmaline oscillation crystal does not serve as a gemstone of the watch 100.

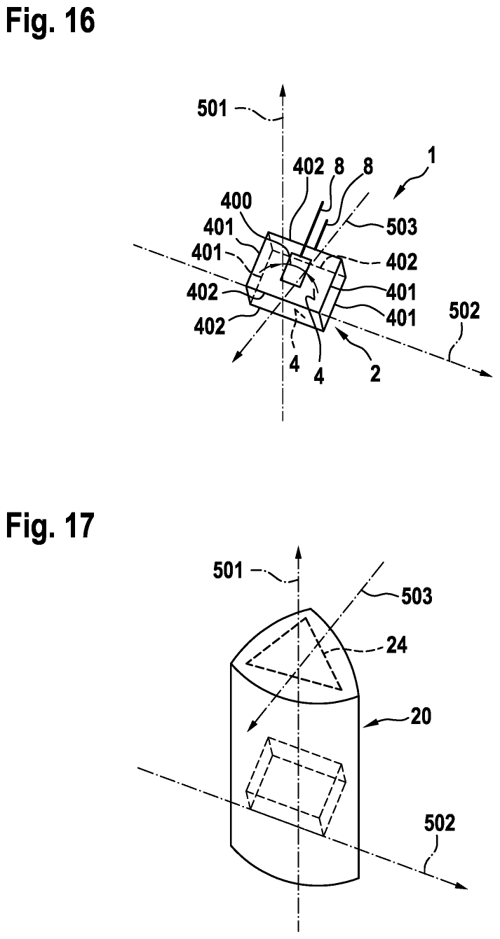

In this case, the clock generator 1 can also be completely covered by the dial 12. FIGS. 16 and 17 refer to a clock generator 1 of a watch 100 according to a fifth embodiment of the present invention.

Like the clock generator 1 according to the first embodiment, the clock generator 1 according to the fifth embodiment comprises a piezoelectric oscillation crystal formed as a tourmaline oscillation crystal with electrodes 8 arranged thereon.

In the tourmaline oscillation crystal according to the fifth embodiment, the electrodes 8 are arranged at surfaces 4 of the tourmaline oscillation crystal, which are at an angle 400 to the L-axis 501. In particular, the angle 400 is between 40 degrees and 50 degrees, preferably 45 degrees.

In this case, the surfaces 4 each comprise two edges 401, which are at the mentioned angle 400 to the L-axis 501, and each two further edges 402, which are parallel to the TA-axis 502.

This means that the oscillation direction of the piezoelectrically excited oscillation of the tourmaline oscillation crystal deviates from the three related axes of the tourmaline oscillation crystal, i.e., the L-axis 501, the TA-axis 502 and the TS-axis 503, and makes use of a polarity that lies between the L-axis 501 and the TA-axis 502.

In particular, the tourmaline oscillation crystal of the preceding embodiments can be made of a rubelite.

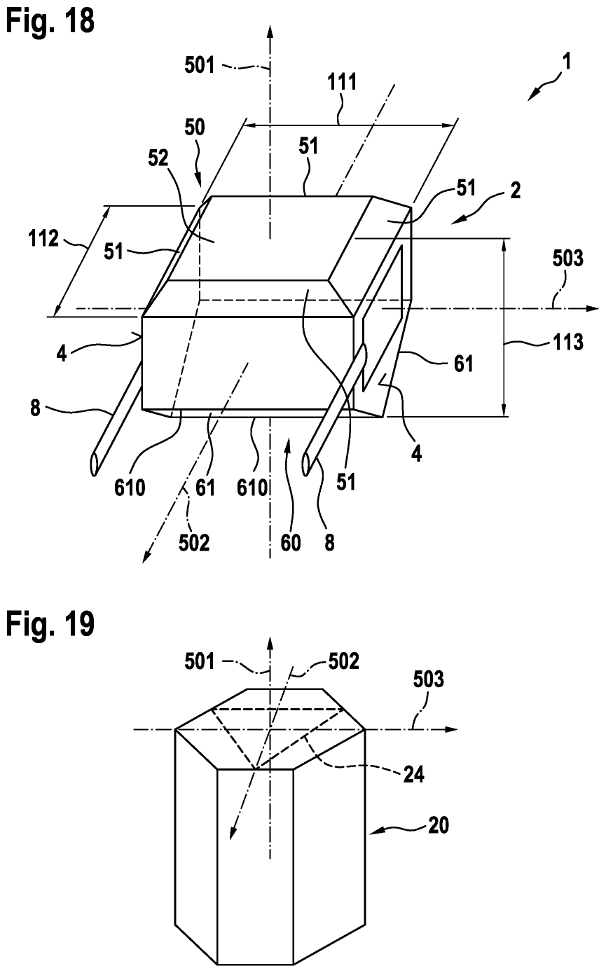

FIGS. 18 and 19 refer to a clock generator 1 of a watch 100 according to a sixth embodiment of the present invention.

Like the clock generator 1 according to the first embodiment, the clock generator 1 according to the sixth embodiment comprises a piezoelectric oscillation crystal 2 formed as a tourmaline oscillation crystal with electrodes 8 arranged thereon.

However, in the tourmaline oscillation crystal according to the sixth embodiment, the electrodes 8 are arranged at surfaces 4, which are perpendicular to the TS-axis 503 and run parallel to the TA-axis 502, wherein the table facet 52 is perpendicular to the L-axis 501.

It further results from FIG. 19 that the tourmaline raw crystal 20, from which the tourmaline oscillation crystal according to the sixth embodiment is formed, comprises a hexagonal structure in contrast to the trigonal structure of the tourmaline raw crystal 20, from which the tourmaline oscillation crystal according to the first initial example is formed.

Like the tourmaline raw crystal 20 of FIGS. 2 and 4, the tourmaline raw crystal 20 with hexagonal structure has an L-axis 501, three TA-axes 502 and three TS-axes 503. Because the TA-axes 502 and the TS-axes are equivalent to each other respectively, only one TA-axis 502 and one TS-axis 503 of the tourmaline raw crystal 20 are shown in FIG. 19. For comparison purposes between a tourmaline raw crystal with a trigonal structure and the tourmaline raw crystal 20 with a hexagonal structure, the structure triangle 24 is also drawn in FIG. 19, using which the tourmaline raw crystal 20 with a trigonal structure can be described. The tourmaline raw crystal 20 with hexagonal structure can be described using a structure hexagon, which in this case coincides with the hexagonal cross-section of the tourmaline raw crystal 20.

The tourmaline raw crystal 20 of FIG. 19, and thus also the tourmaline oscillation crystal of FIG. 18, has the property that it allows light transmission in direction of the L-axis 501, as is the case with some types of tourmaline, for example the pink tourmalines from Nigeria. This has the advantage that light passing through the table facet 52 of the tourmaline oscillation crystal is not swallowed up by it. In addition, the tourmaline oscillation crystal of FIG. 18 has an oscillation direction of a piezoelectrically excited oscillation along the TS-axis 503, in direction of which the tourmaline oscillation crystal has a stronger piezoelectric activity than in direction of the L-axis 501 or TA-axis 502.

For providing the clock generator arrangement 10 according to the previously described embodiments, any arbitrary tourmaline oscillation crystal can be provided first. “Arbitrary” means that a tourmaline raw crystal is cut without regard to what oscillation frequency the tourmaline oscillation crystal to be formed will have. After the tourmaline oscillation crystal is made, an oscillation of the tourmaline oscillation crystal can be generated and the tourmaline oscillation crystal can be measured using a frequency counter to determine its oscillation frequency.

Alternatively, an oscillation frequency for the tourmaline oscillation crystal can first be selected, which the clock generator 1 of the clock generator arrangement 10 comprising the tourmaline oscillation crystal should have. Then, a tourmaline raw crystal is formed such that the tourmaline oscillation crystal has the selected oscillation frequency. In other words, the tourmaline oscillation crystal can be formed, so that it has in its final form a deliberately selected oscillation frequency and not an arbitrary one.

In this case, the clock generator arrangement 10 can in an advantageous manner comprise a useful signal generating device that has a pulse counter, and an output device. The pulse counter is set up to count a clock signal of the clock generator 1 formed as a tourmaline oscillation crystal. The output device is set up to output a useful signal, when a count value of the counted clock signal of the clock generator 1 is equal to a predetermined count value. In other words, the useful signal generating device is set up to generate a useful signal, when a count value of the counted clock signal of the clock generator 1 is equal to a predetermined count value, wherein the output device is set up to output the useful signal. The predetermined count value is derivable from the determined oscillation frequency of the tourmaline oscillation crystal and can, in particular, be stored in a memory of the pulse counter or the output device.

The clock generator 1 comprising a tourmaline oscillation crystal according to the described embodiments can in an advantageous manner have, in its oscillation direction, a selected oscillation frequency, which is a value that has only the number 8 or only the number 8 and the number 0. In particular, the oscillation frequency can be 8888 Hz, 88888 Hz, 888888 Hz, 8888888 Hz, 8 kHz, 88 KHz, 888 KHz or 8888 KHz. Preferably, the oscillation frequency can be 888888 Hz or 888 kHz, wherein the length 111, the width 112 and the height 113 of the tourmaline oscillation crystal are each 8.88 mm and the tourmaline oscillation crystal weighs 8.88 carats.

Again, the clock generator arrangement 10 can comprise a pulse counter and an output device, whereby a useful signal can be generated according to the method of operation described above. For example, when the tourmaline oscillation crystal comprises an oscillation frequency of 888888 Hz, this can be brought down to 8 Hz using a pulse counter, when the predetermined count value is equal to 111111.

It is also possible that the tourmaline oscillation crystal has a selected oscillation frequency in its oscillation direction, which can be brought to a desired frequency, in particular 1 Hz or 8 Hz, by multiple halving. For this purpose, the clock generator arrangement 10 can instead of the pulse counter comprise a frequency divider, which is set up to bring the oscillation frequency of the tourmaline oscillation crystal to the desired frequency, in particular 1 Hz or 8 Hz. The useful signal of the desired frequency can then be output by the frequency divider itself or by a separate output device.

It should be noted that the clock generator arrangement 10 can comprise both a pulse counter and a frequency divider. For example, in the case of a high oscillation frequency of the tourmaline oscillation crystal, e.g., in the amount of 888888 Hz, the oscillation frequency can be halved three times in a first step by means of a frequency divider. In a second step, the intermediate frequency of 111111 Hz present at the output of the frequency divider can be brought to 1 Hz by means of a pulse counter. For this purpose, the predetermined count value of the pulse counter must be set to 111111.

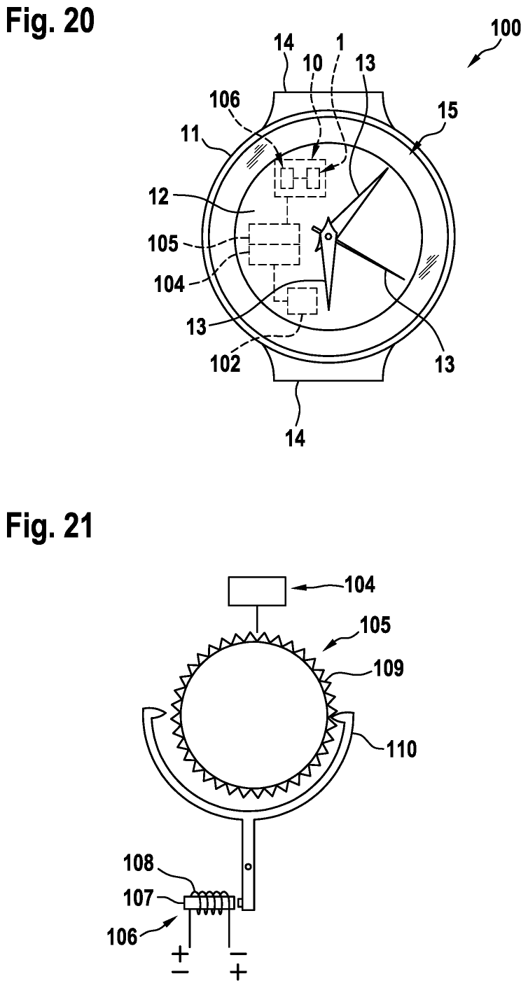

FIGS. 20 and 21 relate to a watch 100 according to a seventh embodiment of the present invention.

In particular, the watch 100 is formed as a self-winding mechanical watch and comprises a clock generator arrangement 10 with a clock generator 1 comprising a piezoelectric oscillation crystal 2, an escapement 105, a gear train 104 and a mechanical watch display device 102 that comprises three hands 13. Alternatively, the watch 100 can be formed as a mechanical watch with hand winding.

The clock generator arrangement 10 of the watch 10 according to the seventh embodiment can in an advantageous manner comprise the components of the previously described clock generator arrangement 10 of the embodiments. In particular, the clock generator 1 can here advantageously be formed like the clock generators 1 of the embodiments described above.

However, the clock generator arrangement 10 of the watch 100 according to the seventh embodiment further comprises an electromechanical device 106. It can in particular be derived from FIG. 21 that the electromechanical device 106 is formed in particular as an actuator comprising a magnetic armature (magnetic core) 107 and a magnetic coil 108. Here, the magnetic coil 108 interacts with the magnetic armature 107. In particular, the magnetic coil 108 is set up to move the magnetic armature 107, when it is energized.

The electromechanical device 106 is movable using a useful signal based on the oscillation frequency of the clock generator 1. As a result, the electromechanical device 106, in particular the magnetic armature 107, engages with the gear train 104 in a clocked manner.

As can also be seen from FIG. 20, the escapement 105 is arranged between the clock generator arrangement 10, in particular the electromechanical device 106, and the gear train 104. Thus, the electromechanical device 106, in particular the magnetic armature 107, indirectly engages with the gear train 104 via the escapement 105. The escapement 105 is driveable by the electromechanical device 106.

In particular, the electromechanical device 106 indirectly engages with the gear train 104 in an inhibiting manner to alternately bring the gear train 104 to a standstill and release it again.

It can be further derived from FIG. 21 that the escapement 105 comprises an escapement wheel 109 and an inhibition piece 110 and is formed, in particular, as an anchor escapement. The escapement wheel 109 is in this case in engagement with the gear train 104, wherein the magnetic armature 107 can due to its movement be brought into engagement with the inhibition piece 110. In particular, the inhibition piece 110 is drivable by the magnetic armature 107.

In particular, the magnetic coil 108 builds up and removes a magnetic field in the rhythm of the useful signal, whereby the magnetic armature 107 is moved back and forth also in the rhythm of the useful signal. The moving magnetic armature 107 then engages with the inhibition piece 110, and replaces thereby a conventional balance wheel of a mechanical watch.

The watch 100 can thus be timed more precisely.

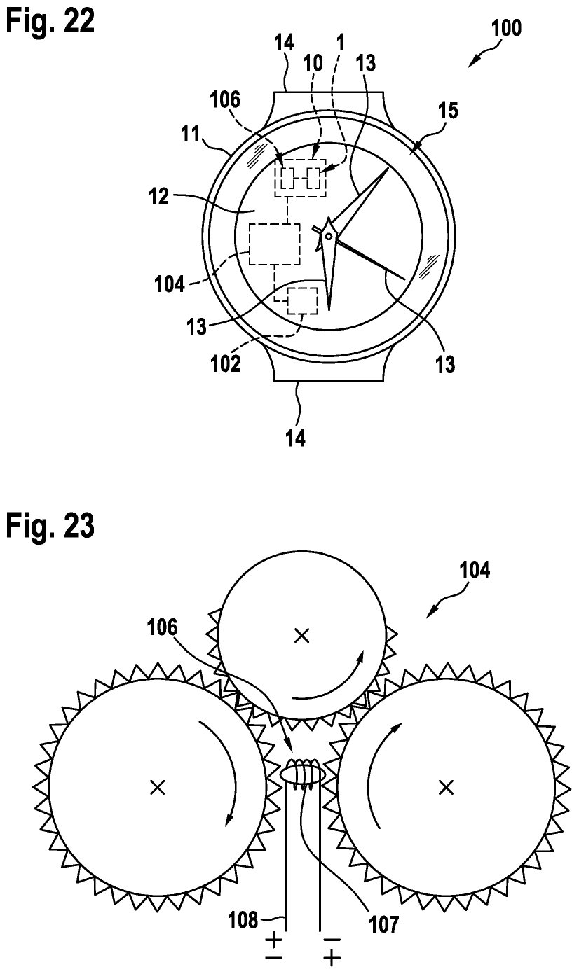

FIGS. 22 and 23 relate to a watch 100 according to an eighth embodiment of the present invention.

The watch 100 according to the eighth embodiment differs from the watch 100 according to the seventh embodiment in that no escapement is provided in the watch 100 according to the eighth embodiment.

In this design of the watch 100, the electromechanical device 106 is formed and set up to directly engage with the gear train 104 in a clocked manner. Therefore, the clock generator arrangement 10 of the watch 100 according to the eighth embodiment plays the role of the combination of a conventional balance wheel and a conventional escapement.

In particular, the electromechanical device directly engages with the gear train 104 in an inhibiting manner in order to alternately bring the gear train 104 to a standstill and release it again.

In the watch 100 according to the eighth embodiment, the electromechanical device 106 is also formed as an actuator that comprises a magnetic armature 107 and a magnetic coil 108.

Thus, the magnetic armature 107 engages directly in a clocked manner with the gear train 104.

However, it is also possible that the electromechanical device 106 is formed as a stepper motor, which engages directly in a clocked manner with the gear train 104.

In this case, the electric stepper motor is set up to engage directly with the gear train 105. In such a design, a main spring of the watch and the electric stepper motor are advantageously formed in such a manner that the main spring does not have the power to further rotate the electric stepper motor without the electric stepper motor being supplied with power. The electric stepper motor would thus replace a conventional balance wheel and a conventional escapement. Furthermore, the electric stepper motor can advantageously function as a drive element for driving the mechanical watch display device 102 or rather for moving the hands 13, when the main spring (drive spring) of the watch 100 is discharged.

Except for the described features of the watch 100 according to this embodiment, its operation method basically corresponds to that of the watch 100 according to the seventh embodiment. Here, however, the electromechanical device 106 does not control an escapement, but instead directly controls the gear train 104, which is thus clocked.

In the preceding embodiments, the electrodes 8 are shown in the corresponding drawings as electrodes 8 attached to the surfaces 4 of the respective piezoelectric oscillation crystal 2. That is, the electrodes 8 are connected to the surfaces 4 of the piezoelectric oscillation crystal 2. In particular, the electrodes 8 can be materially attached, preferably glued, to the surfaces 4 of the piezoelectric oscillation crystal 2.

However, it is also possible that the electrodes 8 are not connected to the piezoelectric oscillation crystal 2, but formed as separate elements.

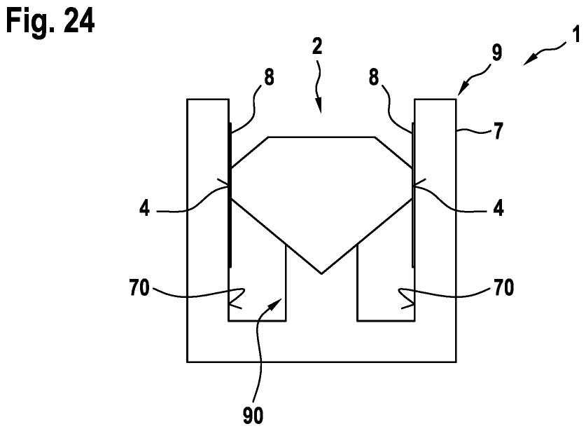

FIG. 24 shows a simplified schematic view of an electrode arrangement 9, by which electrodes 8 formed independently of the piezoelectric oscillation crystal 2 are provided.

The electrode arrangement 9, which is formed as a separate component from the piezoelectric oscillation crystal 2, comprises an electrode holder 7, to which the electrodes 8 are attached.

The electrodes 8 are formed at surfaces of the electrode holder 7. In particular, the electrodes 8 can be separate current-conducting elements, which are connected to the surfaces 70 of the electrode holder 7. Alternatively, the electrodes 8 can be applied as current-conducting layers on the surfaces 70 of the electrode holder 7.

An electrical voltage can be applied to the electrodes 8, so that the piezoelectric oscillation crystal is caused to oscillate.

The electrode holder 7 is advantageously formed such that at a maximum oscillation amplitude of the piezoelectric oscillation crystal 2, i.e. at a maximum mechanical deformation of the oscillation crystal 2, the surfaces 70 of the electrode holder 7, at which the electrodes 8 are formed, are in contact with the piezoelectric oscillation crystal 2 or rather the surfaces 4 of the piezoelectric oscillation crystal 2, to which the electrical voltage must be applied, or are arranged at a distance from the oscillation crystal 2 or rather from the said surfaces 4 of the oscillation crystal 2.

In the latter case, the electrodes 8 do thus not touch the piezoelectric oscillation crystal 2. Here, the electrode holder 7 is advantageously formed such that the distance is small enough that, when a voltage is applied to the electrodes 8, a piezoelectric oscillation of the piezoelectric oscillation crystal 2 can be initiated and maintained. A gap between each surface 70 of the electrode holder 7 and the corresponding surface 4 of the piezoelectric oscillation crystal 2 can preferably be between 0.1 mm and 0.3 mm. In this case, the electric charge is transferred on the piezoelectric oscillation crystal 2 only by a charge field, not by direct contact with the piezoelectric oscillation crystal 2. Thus, the piezoelectric oscillation crystal 2 can expand and retract.

The electrode arrangement 9 preferably also serves as a holder for holding the piezoelectric oscillation crystal 2. For this purpose, the electrode holder 9 preferably has a receiving area (holding area) 90 for receiving and holding the piezoelectric oscillation crystal 2.

Using the electrode arrangement 9, the piezoelectric oscillation crystal can, in view of damping otherwise caused by the electrodes 8, oscillate without damping.

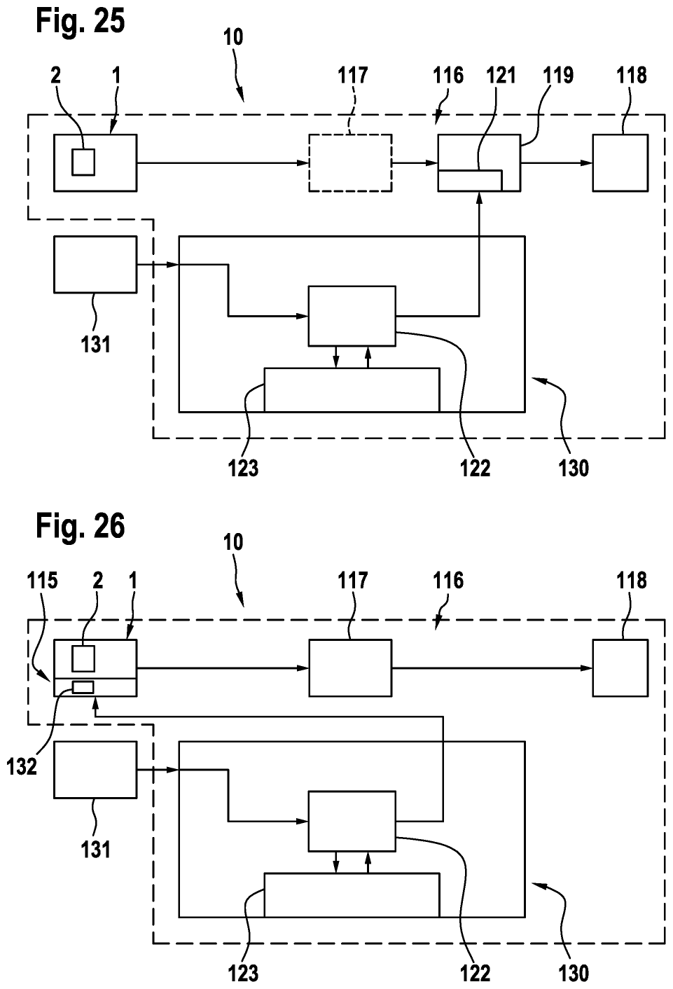

In FIG. 25, a clock generator arrangement 10 in a watch 100 according to the present invention is shown.

The clock generator arrangement 10 comprises a useful signal generating device 116 comprising a pulse counter 119 with a comparator 121. The pulse counter 119 is formed for counting a clock signal of the clock generator 1.

The useful signal generating device 116 is set up to generate a useful signal based on the oscillation frequency of the piezoelectric oscillation crystal 2. In particular, the useful signal generating device 116 is set up to generate the useful signal, when a count value of the counted clock signal of the clock generator is equal to a predetermined count value.

Optionally, the useful signal generating device 116 can also comprise a frequency divider 117. In this case, the pulse counter 119 is formed for counting a signal based on a clock signal of the clock generator, in this case the output signal of the frequency divider 117. The useful signal generating device 116 is set up to generate the useful signal, when a count value of the counted output signal of the frequency divider is equal to a predetermined count value.

The clock generator arrangement 10 further comprises an output device 118 set up to output the useful signal generated by the useful signal generating device 116.

Preferably, the clock generator arrangement 10 comprises a control unit 122 set up to correct the predetermined count value depending on a temperature of the clock generator 1 and/or a temperature of the watch 100 in the surroundings of the clock generator 1.

For this purpose, a table with temperature-dependent predetermined count values (predetermined count values that are assigned to temperatures) and/or a function of the predetermined count value depending on the temperature of the clock generator 1 and/or the temperature of the watch 100 in the surroundings of the clock generator 1 can preferably be stored in a memory unit 123. The control unit 122 and the memory unit 123 can preferably be parts of a microcontroller 130.

A temperature sensor 131 is preferably provided in the watch 100 for detecting the present temperature of the clock generator 1 and/or a temperature of the watch 100 in the surroundings of the clock generator 1. The temperature sensor 131 can also be integrated in the microcontroller 130.

The control unit 122 preferably periodically reads out the temperature sensor 131 and calculates using the stored function the associated predetermined count value or retrieves it from the stored table. It preferably writes this associated predetermined count value into a memory of the comparator 121. As a result, the useful signal generating device 116 generates the useful signal, when the count value of the clock signal of the clock generator 1 counted by the pulse counter 119 or of the output signal of the frequency divider 117, when a frequency divider 117 is provided as described above, is equal to the aforementioned associated predetermined count value, i.e., with the predetermined count value (corrected count value) associated with the present temperature.

Thus, a temperature-dependent oscillation frequency deviation of the piezoelectric oscillation crystal 2 can be compensated.

Because the temperature inside the watch 100 generally changes only slowly, this compensation process can be carried out not very often, but at a distance of a few minutes or so. It therefore requires only a minimal costs of calculation and thus energy.

In FIG. 26, a clock generator arrangement 10 in a watch 100 according to the present invention is shown.

This clock generator arrangement 10 differs from the clock generator arrangement 10 of FIG. 25 in that the present clock generator arrangement 10 does not have a pulse counter.

Furthermore, the oscillator circuit 115 for exciting a piezoelectric oscillation of the piezoelectric oscillation crystal 2 of the clock generator 1 is shown in FIG. 26.

The oscillator circuit 115 comprises a capacitance diode 132. It is operated in an advantageous manner in the reverse direction (i.e., it flows practically no current). By adjusting the capacitance, in particular the junction capacitance, of the capacitance diode 132, the oscillation frequency of the piezoelectric oscillation crystal 2 can be adjusted. The junction capacitance depends in a defined manner on the applied reverse voltage. Thus, such a diode represents a capacitor of variable capacitance (trimming capacitor).

A function or table is stored in the memory unit 123, which indicates which reverse voltage must be applied to the capacitance diode 132 as a function of the temperature of the clock generator 1 or in the surroundings of the clock generator 1, so that its junction capacitance has the correct value for temperature compensation. In particular, the table can comprise temperature-dependent values for the reverse voltage (predetermined values for the reverse voltage that are assigned to temperatures). In particular, the function is a function of the value of the reverse voltage depending on the temperature.

The control unit 122 reads out the temperature sensor and identifies the associated voltage value, which is applied to the capacitance diode in particular via an analog output of the microcontroller 130.

Thus, a temperature-dependent oscillation frequency deviation of the piezoelectric oscillation crystal 2 can be compensated.

It should be noted that the clock generator 1 of the clock generator arrangement 10 of FIGS. 25 and 26 can be formed like one of the previously described clock generators 1. Correspondingly, the clock generator arrangement 10 of FIGS. 25 and 26 can be provided in the previously described watches 100. This means in particular that the temperature compensation described with reference to FIGS. 25 and 26 can be implemented in the previously described watches 100.

However, it should also be noted that the clock generator arrangement 10 of FIGS. 25 and 26 can also be implemented for temperature compensation in connection with piezoelectric oscillation crystals that do not have a length, a width and a height of at least 1 mm, preferably of at least 1.5 mm, respectively.

In addition to the above written description of the invention, for the purpose of its supplementary disclosure, explicit reference is hereby made to the graphic representation of the invention in FIGS. 1 to 26.

1. A watch, in particular wristwatch, comprising:
a clock generator arrangement, which comprises a clock generator, wherein the clock generator comprises a piezoelectric oscillation crystal and electrodes, wherein the piezoelectric oscillation crystal has a length, a width and a height each of at least 1 mm, preferably of at least 1.5 mm, and
a watch case, in which the clock generator arrangement is arranged.

2. The watch of claim 1, wherein the watch has a transparent region and the piezoelectric oscillation crystal is formed and arranged in the watch such that the piezoelectric oscillation crystal is visible through the transparent region of the watch, so that the piezoelectric oscillation crystal serves as a gemstone of the watch.

3. The watch of claim 1, wherein;
the piezoelectric oscillation crystal has a pavilion with pavilion facets, wherein a pavilion angle is selected such that a double total reflection of light occurs in the pavilion, or
the piezoelectric oscillation crystal has a plurality of facets at its bottom side, which form a plurality of protrusions, wherein the protrusions are arranged such that the protrusions form a corrugated profile, and wherein the facets of a respective protrusion are arranged at an angle to each other, which is selected such that a double total reflection of light occurs in the protrusion.

4. The watch of claim 1, wherein the piezoelectric oscillation crystal is a natural tourmaline oscillation crystal, which has an L-axis, three TA-axes and three TS-axes,
preferably wherein the tourmaline oscillation crystal is formed from a tourmaline raw crystal, which has a trigonal or hexagonal structure.

5. The watch of claim 4, wherein:
the tourmaline oscillation crystal comprises a table facet, which is perpendicular to the L-axis, a TA-axis or a TS-axis, and the tourmaline oscillation crystal preferably allows light transmission in direction of the L-axis, or
the tourmaline oscillation crystal comprises a table facet, which is perpendicular to a TA-axis or a TS-axis and the tourmaline oscillation crystal preferably blocks light transmission in direction of the L-axis.

6. The watch of claim 4, wherein the electrodes are arranged at surfaces of the tourmaline oscillation crystal, which are perpendicular to the L-axis.

7. The watch of claim 6, wherein:
the tourmaline oscillation crystal has pavilion facets, which are inclined towards a TS-axis or a TA-axis and each comprise two edges, which run parallel to the L-axis, wherein in particular a pavilion angle is between 40 degrees and 50 degrees, and preferably at least 42 degrees, or
the tourmaline oscillation crystal has at its bottom side a plurality of facets, which form a plurality of protrusions, wherein the protrusions are arranged such that the protrusions form a corrugated profile, and wherein the facets of a respective protrusion are at an angle to a plane, which is parallel to a table facet of the tourmaline oscillation crystal, wherein the angle is between 40 degrees and 50 degrees, and preferably at least 42 degrees.

8. The watch of claim 4, wherein the electrodes are arranged at surfaces of the tourmaline oscillation crystal, which are perpendicular to a TA-axis and run parallel to the L-axis.

9. The watch of claim 4, wherein the electrodes are arranged at surfaces of the tourmaline oscillation crystal, which are perpendicular to a TS-axis and run parallel to the L-axis.

10. The watch of claim 9, wherein the tourmaline oscillation crystal has pavilion facets, which are inclined towards a TA-axis, wherein in particular a pavilion angle is between 40 degrees and 50 degrees, and preferably at least 42 degrees.

11. The watch of claim 4, wherein:
the electrodes are arranged at surfaces of the tourmaline oscillation crystal, which each have an edge, which is at an angle of 40 degrees to 50 degrees, preferably 45 degrees, to the L-axis, and each have a further edge, which is parallel to a TA-axis or a TS-axis, and/or
the tourmaline oscillation crystal has a table facet, which comprises an edge, which is at an angle of 40 degrees to 50 degrees, preferably 45 degrees, to the L-axis, and a further edge, which is parallel to a TA-axis or a TS-axis, and/or
the tourmaline oscillation crystal has pavilion facets, which are inclined towards a normal vector of a table facet of the piezoelectric oscillation crystal, wherein in particular a pavilion angle is between 40 degrees and 50 degrees, and preferably at least 42 degrees, or wherein the piezoelectric oscillation crystal has at its bottom side a plurality of facets, which are inclined towards a normal vector of a table facet of the piezoelectric oscillation crystal and form a plurality of protrusions, wherein the protrusions are arranged such that the protrusions form a corrugated profile, and wherein the facets of a respective protrusion are at an angle to a plane, which is parallel to a table facet of the tourmaline oscillation crystal, wherein the angle is between 40 degrees and 50 degrees, and preferably at least 42 degrees.

12. The watch claim 1, wherein the piezoelectric oscillation crystal is a natural tourmaline oscillation crystal, which is formed from a tourmaline raw crystal, which has a structure between a trigonal structure and a hexagonal structure.

13. The watch claim 1, wherein the piezoelectric oscillation crystal is a rubelite.

14. The watch of claim 1, wherein the piezoelectric oscillation crystal has in its oscillation direction an oscillation frequency, which has a value, which has only the number 8 or only the number 8 and the number 0, wherein the oscillation frequency is in particular 8888 Hz, 88888 Hz, 888888 Hz, 8888888 Hz, 8 kHz, 88 KHz, 888 KHz or 8888 KHz,
preferably wherein the piezoelectric oscillation crystal is a tourmaline oscillation crystal, in which the oscillation frequency is 888888 Hz or 888 kHz, the length, the width (112) and the height (113) are each 8.88 mm and which weighs 8.88 carats.

15. The watch of claim 1, wherein the piezoelectric oscillation crystal has in its oscillation direction an oscillation frequency, which can be brought to a desired frequency, in particular of 1 Hz or 8 Hz, by multiple halving, wherein the watch preferably comprises a frequency divider, which is set up to bring the oscillation frequency of the clock generator to the desired frequency, in particular of 1 Hz or 8 Hz.

16. The watch of claim 1, further comprising an oscillation circuit, which is set up to excite the piezoelectric oscillation crystal to oscillate, wherein the oscillation circuit preferably comprises a trimming capacitor, particularly preferably a capacitance diode, for setting the oscillation frequency of the piezoelectric oscillation crystal by setting a capacitance of the trimming capacitor, particularly preferably of the capacitance diode, via an electrical signal, wherein a control unit is set up to set the electrical signal depending on a temperature of the clock generator and/or a temperature of the watch in the surroundings of the clock generator.

17. The watch of claim 1, wherein the watch further comprises a gear train and wherein the clock generator arrangement further comprises an electromechanical device, which is movable by using a useful signal based on the oscillation frequency of the piezoelectric oscillation crystal, whereby the electromechanical device directly or indirectly engages with the gear train in a clocked manner,
preferably wherein the electromechanical device engages indirectly with the gear train, wherefore the watch comprises an escapement, which is in engagement with the gear train and is drivable with the electromechanical device,
wherein in particular the electromechanical device is formed as an actuator, preferably wherein the actuator has a magnet armature and a magnet coil, which is set up to move the magnet armature by using the useful signal, or
preferably wherein the electromechanical device is formed as a stepper motor.

18. The watch of claim 1, wherein the clock generator arrangement comprises a useful signal generating device for generating a useful signal based on the oscillation frequency of the piezoelectric oscillation crystal, preferably wherein the useful signal generating device has a pulse counter for counting a clock signal of the clock generator or a signal based on a clock signal of the clock generator and is set up to generate the useful signal, when a count value of the counted clock signal of the clock generator or the counted signal based on the clock signal of the clock generator is equal to a predetermined count value, wherein a control unit is preferably set up to correct the predetermined count value depending on a temperature of the clock generator and/or a temperature of the watch in the surroundings of the clock generator.

19. The watch of claim 1, wherein the electrodes are attached to the piezoelectric oscillation crystal or wherein the clock generator comprises an electrode arrangement, which has an electrode holder, to which the electrodes are attached.

20. A method for manufacturing a watch, in particular a wristwatch, comprising the following steps:
providing a clock generator arrangement, which comprises a clock generator, wherein the clock generator comprises a piezoelectric oscillation crystal and electrodes, wherein the piezoelectric oscillation crystal has a length, a width and a height each of at least 1 mm, preferably at least 1.5 mm, and
arranging the clock generator arrangement in a watch case.
